(19) United States
(12) Patent Application Publication
(10) Pub. No.: US 2023/0131242 A1
(43) Pub. Date: Apr. 27, 2023

(54) Interactive Toy System

(71) Applicant: Mattel, Inc., El Segundo, CA (US)

(72) Inventors: Carolyn Holden Buse, Santa Monica, CA (US); Natalie Repp Zigal, Los Angeles, CA (US); Agata Sikorski, New York, NY (US); Scott Basu, San Pedro, CA (US); Brian Hong, Valencia, CA (US); Patricia Chan, Redondo Beach, CA (US); Todd Gionet, Fountain Valley, CA (US); James Molina, Westminster, CA (US); Lilit Pilikian, Granada Hills, CA (US); Karishma Rajiv Donde, Los Angeles, CA (US); Eric Lau, Hong Kong (CN); Shum Wai Hang, Hong Kong (CN); Vincent Zhou, Guangdong (CN)

(21) Appl. No.: 17/510,599

(22) Filed: Oct. 26, 2021

(51) Int. Cl. A63H 3/28; A63H 3/00; A63H 3/52; G06K 7/10

(52) U.S. Cl. CPC A63H 3/28; A63H 3/006; A63H 3/52; G06K 7/10297; A63H 2200/00

(57) ABSTRACT

An interactive toy system is disclosed. The interactive toy system is or includes a toy figurine with a head, a torso, at one or more appendages. The toy figurine also includes a first tag reader disposed in the torso, a second tag reader disposed in a first appendage of the one or more appendages, and an effects module configured to produce a sound effect, a light effect. Still further, the toy figurine includes control circuitry configured to cause the effects module to produce a first effect when the first tag reader reads a first tag and cause the effects module to produce a second effect when the second tag reader reads the first tag.

### FIELD OF THE INVENTION

The present application relates to interactive toy systems and, specifically, to an interactive toy figurine or doll that employs NFC and/or RFID technologies, for example, to read data from accessories and/or playsets of the toy system.

### BACKGROUND

Toy dolls and figurines have been and continue to be a stable source of amusement for children. However, enhancements, accessories, and features that spark a child's imagination and provide continued engagement with the toy doll add to a doll's play value and build a bond between the child and the toy doll. Consequently, there is a need for toys with creative play features, and in particular, a toy doll or figurine that can interact with other toys, accessories, and/or playsets in unique and interesting manners to capture a child's attention and increase the play value of a toy figurine.

Near Field Communications (NFC) refers to a technology that allows radio-frequency devices, such as mobile phones, to establish wireless communications over short distances, typically within a few centimeters. For example, an NFC-enabled mobile phone may read data from NFC tags and/or other NFC-enabled devices in close proximity, without direct contact. Radio-Frequency Identification (RFID) refers to a similar technology that enables wireless data transfer. For example, an RFID reader may read data from an RFID tag attached to an object, e.g., to identify a product in an inventory control system. Electronic toys and games may employ NFC and/or RFID technologies to read data over short distances. For example, a game console may read data from a trading card that contains an NFC tag.

### SUMMARY

According to at least one embodiment of the present invention, a toy system is disclosed. The toy system includes a first accessory including a first tag and a toy. The toy includes a head, a torso, and one or more appendages. The toy also includes a first tag reader and a second tag reader disposed in the torso, the one or more appendages, or a combination thereof, an effects module configured to produce a sound effect, a light effect, or a combination thereof, and control circuitry. The control circuitry is configured to cause the effects module to produce a first effect when the first tag reader reads the first tag and cause the effects module to produce a second effect when the second tag reader reads the first tag.

In at least some embodiments, the control circuitry causes the effects module to produce a third effect when the first tag reader or the second tag reader reads a second tag included in a second accessory within a predetermined amount of time of reading the first tag. For example, the first effect may be a sound effect associated with the first accessory, the second effect may be a sound effect associated with the second accessory, and the third effect may be a multi-layered sound effect including layers associated with the first accessory and the second accessory. Additionally or alternatively, the control circuitry may be configured to cause the effects module to produce a fourth effect when the first tag reader or the second tag reader reads the first tag within a predetermined amount of time of reading the second tag. In at least some embodiments, the third effect and the fourth effect are different multi-layered sound effects, but each include layers associated with the first accessory and the second accessory. Still further, in some embodiments, the control circuitry may cause the effects module to produce a fifth effect when the second tag reader reads a third tag of a third accessory within a predetermined amount of time of reading the first tag.

In some embodiments, the first accessory is part of a first set of accessories, the first tag is part of a first set of tags, and the toy system also includes a second accessory including an update tag. The update tag is configured to update the control circuitry to recognize a second set of accessories including tags from a second set of tags, the second set of tags including tags that are unique from the first set of tags included in the first set of accessories. As an example, the second accessory may be a piece of clothing and the update tag may be included in a pocket disposed on a back portion of the piece of clothing. Additionally or alternatively, the first accessory may be configured to draw power from the toy when the first tag reader or the second tag reader reads the first tag.

According to another embodiment, the present application is directed to a toy figurine including a head, a torso, and at one or more appendages, a first tag reader disposed in the torso, and a second tag reader disposed in a first appendage of the one or more appendages. The toy figurine also includes an effects module configured to produce a sound effect, a light effect, or a combination thereof (e.g., a speaker configured to emit audio) and control circuitry. The control circuitry causes the effects module to produce a first effect when the first tag reader reads a first tag and causes the effects module to produce a second effect when the second tag reader reads the first tag.

In at least some embodiments, the first appendage is an arm that includes an elbow and the elbow defines a circular wire path for a wire connecting the second tag reader to the control circuitry while allowing articulation of the arm about the elbow. In some of these embodiments, the elbow includes a split boss including a slot and a rounded outer edge. The circular wire path extends from an upper arm portion of the arm to a lower portion of the arm by extending through the slot and wrapping around a portion of the rounded outer edge.

According to yet another embodiment, the present application is directed to a method of controlling interactions in an interactive toy system. The method includes receiving, at a processor included in a smart toy of an interactive toy play system, data received from a first tag read by a tag reader of the smart toy. When a first tag reader read the first tag, the processor causes an effects module included in the smart toy to produce a first effect. When a second tag reader read the first tag, the processor causes the effects module to produce a second effect.

### BRIEF DESCRIPTION OF THE DRAWINGS

FIG. 1A illustrates an interactive toy system including a toy figurine and an accessory, the toy figurine interacting with the accessory in a first interaction, according to an example embodiment.

FIG. 1B illustrates the interactive toy system of FIG. 1A while the toy figurine is interacting with the accessory in a second interaction, according to an example embodiment.

FIG. 2 illustrates a front view of a portion of a toy figurine that may be included in the toy system presented herein, according to an example embodiment.

FIG. 3 illustrates a back view of a portion of the toy figurine of FIG. 2.

FIG. 4 is a block diagram illustrating example components that may be included in a smart toy of the interactive toy system presented herein, according to an example embodiment.

FIG. 5 illustrates an example embodiment of a tag table that may be stored in the memory of FIG. 4, according to an example embodiment.

FIG. 6 illustrates a method that may be executed by computing components included in a smart toy of the interactive toy system presented herein, according to an example embodiment.

FIG. 7A illustrates an exploded view of a first accessory that may be included in the interactive toy system presented herein, according to an example embodiment.

FIG. 7B illustrates a back perspective view of the first accessory of FIG. 7A.

FIG. 8 illustrates a partially exploded view of a second accessory that may be included in the interactive toy system presented herein, according to an example embodiment.

FIG. 9 illustrates a first accessory set that may be included in the interactive toy system presented herein, according to an example embodiment.

FIG. 10 illustrates a second accessory set that may be included in the interactive toy system presented herein, according to an example embodiment.

FIG. 11 illustrates a back view of an update accessory included in the second accessory set of FIG. 10.

FIG. 12 illustrates a sectional view of the update accessory of FIG. 11.

FIGS. 13A and 13B illustrate front and rear perspective views of a first playset that may be included in the interactive toy system presented herein, according to an example embodiment.

FIG. 14 illustrates a front perspective view of a second playset that may be included in the interactive toy system presented herein, according to an example embodiment.

FIG. 15 illustrates interconnected playsets that may be included in the interactive toy system presented herein, according to an example embodiment.

FIG. 16 illustrates a first embodiment of a wired arm that may be included in a figurine of the interactive toy system presented herein, the wired arm being illustrated with an unwired arm.

FIG. 17 illustrates a sectional view of the wired arm of FIG. 16.

FIGS. 18A-18C illustrate partial sectional views of the wired arm of FIG. 16.

FIGS. 19A and 19B illustrate an elbow joint of the wired arm of FIG. 16 during movement of the wired arm about the elbow joint.

FIGS. 20 and 21 illustrate partial sectional views of a hand and a shoulder included in the wired arm of FIG. 16, respectively.

FIG. 22 illustrates a partial sectional view of a second example embodiment of a wired arm that may be included in a figurine of the interactive toy system presented herein.

FIG. 23 illustrates internal components of the wired arm of FIG. 22.

FIGS. 24A and 24B illustrate a first and second internal component from FIG. 22, respectively.

FIG. 25 illustrates a third example embodiment of a wired arm that may be included in a figurine of the interactive toy system presented herein, the arm being illustrated with an unwired arm.

FIG. 26 illustrates a sectional view of the wired arm of FIG. 25.

FIGS. 27 and 28 illustrate the pair of arms of FIG. 25 with different articulation options included therein.

FIG. 29 is a circuitry diagram depicting circuitry that can form an update tag, such as an update tag included in an accessory of the interactive toy system presented herein, according to an example embodiment.

FIGS. 30-33 are circuitry diagrams depicting circuitry that can be included in an interactive toy, such as an interactive toy figurine, of the interactive toy system presented herein, according to an example embodiment.

FIGS. 34-36 are flow charts depicting operational sequences that can be implemented by an interactive toy, such as an interactive toy figurine, of the interactive toy system presented herein, according to an example embodiment. For example, the operational sequences depicted in FIGS. 34-36 may be executed by the circuitry of FIGS. 30-33.

Like reference numerals have been used to identify like elements throughout this disclosure.

### DETAILED DESCRIPTION

Generally, the present application is drawn to an interactive toy system. The toy system includes a toy, such as a toy figurine, with internal computing components configured to read tags included in accessories, playsets, and/or additional toys and produce effects, such as sound and/or light effects, in response to an identity of the tag that is read and/or the manner in which the tag is read. More specifically, the toy with internal computing components (e.g., the toy figurine) may include a plurality of tag readers and may produce different effects (e.g., different sound effects) when tags are read by different tag readers. Additionally or alternatively, the toy with internal computing components (e.g., the toy figurine) may produce layered effects when multiple tags are read in different sequences.

Still further, in some instances, the toy with internal computing components (e.g., the toy figurine) may deliver power to additional components of the interactive toy system that include electrical or electro-mechanical components so that the additional components can generate effects (e.g., lights, sounds, and/or motions). Additionally or alternatively, in some instances, the toy with internal computing components (e.g., the toy figurine) can communicate with playsets and/or additional toys with internal computing components (e.g., additional toy figurines) to generate effects. For example, if the toy with internal computing components (e.g., the toy figurine) has internal tags, bringing the toy into proximity with playsets and/or additional toys may allow playsets and/or additional toys to read a tag included in the toy and generate an effect associated with the tag.

For the purposes of this application, components of the interactive toy that include internal computing components (e.g., a toy figurine) may be referred to herein as “primary” or “smart” components, such as a “smart figurine.” By comparison, components of the interactive toy system that do not include computing components may be referred to as “semi-dumb” or “dumb” components. “Semi-dumb” components may include electronics configured to interact with a smart toy while “dumb” components may not include any electronic or electro-mechanical components configured to interact with a smart toy. Put another way, a smart toy can produce an effect in response to reading a tag in a “semi-dumb” component and/or cause the “semi-dumb” component to generate an effect. By comparison, a smart toy can produce an effect in response to reading a tag in a “dumb” component, but cannot cause the “dumb” component to generate an effect. Moreover, just to be clear, in some instances, a smart toy can produce an effect in response to reading a tag in a “smart” component and/or cause the “smart” component to generate an effect (e.g., to initiate a “conversation” or interaction between two smart figurines).

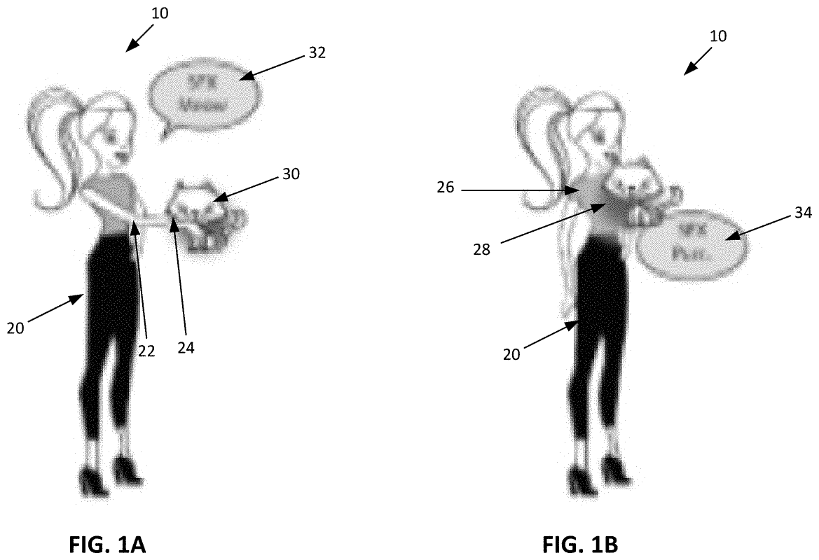

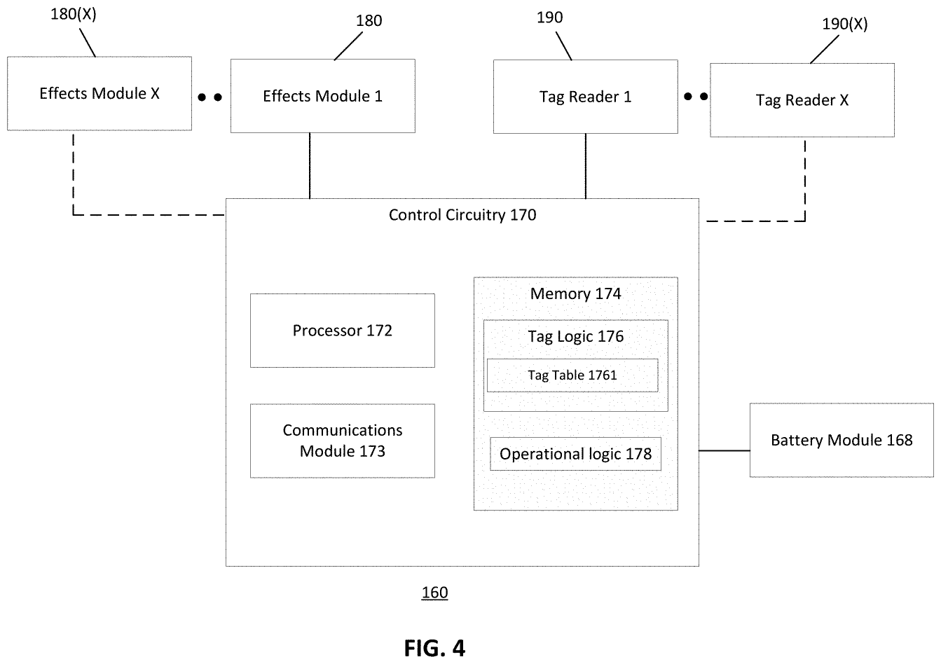

Now turning to FIGS. 1A and 1B, these figures illustrate an interactive toy system of the present application at a high-level. In these figures, the interactive toy system 10 includes a smart figurine 20 and a dumb accessory 30 with an internal tag (not shown). The smart figurine 20 includes an appendage 22 with a first tag reader 24 and a torso 26 with a second tag reader 28. As is described in further detail below, readers 24 and 28 may be or include Near Field Communications (NFC) or Radio Frequency Identification (RFID) transceivers. The smart figurine 20 also includes internal computing components configured to generate an effect based on data received from tag readers 24 and 28, which are described in further detail below in connection with FIG. 4.

As is illustrated at a high-level, the smart figurine 20 is configured to generate a first effect 32 (e.g., a first sound effect) when a tag included in accessory 30 is read at the first tag reader 24 (see FIG. 1A). By comparison, if a tag included in accessory 30 is read at the second tag reader 28 (see FIG. 1B), the smart figurine 20 generates a second effect 34 (e.g., a second sound effect) that is different from the first effect. In at least some embodiments, the effect is associated with the accessory, even though the sound may emanate from the smart figurine 20. This imparts play value to accessories, playsets, etc., without requiring these components to include electronic and/or computing components. As an example, in the depicted embodiment, accessory 30 is a cat and thus, the smart figurine may produce a first cat sound as first effect 32 (e.g., a “meow” sound) and a second cat sound as second effect 34 (e.g., a purring sound). Thus, accessory 30 need not include a speaker to provide sounds that increase the play value of accessory 30.

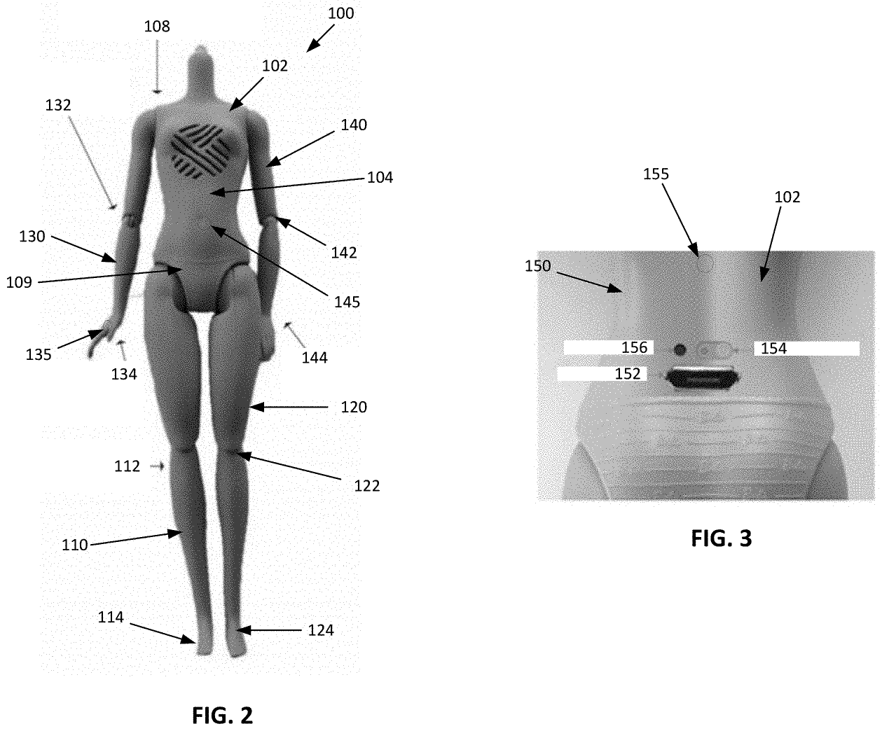

Now turning to FIG. 2, as mentioned, in at least some embodiments, the “smart” or “primary” component of the interactive toy system presented herein is a toy figurine. FIG. 2 illustrates a toy figurine 100 as an example of one such smart toy figurine. The toy figurine 100 includes a torso 102 with a front 104, a back 150 (see FIG. 3), shoulders 108, and hips 109 that support a number of appendages. Specifically, the torso 102 supports a first leg 110, a second leg 120, a first arm 130, and a second arm 140. Leg 110 includes a knee 112 and a foot 114 while leg 120 includes a knee 122 and a foot 124. Arm 130 includes an elbow 132 and a hand 134 while arm 140 includes elbow 142 and hand 144. In different embodiments, knees 112 and 122, feet 114 and 124, elbows 132 and 142, and/or hands 134 and 144 may be articulable or rigid to provide different degrees of flexibility in leg 110, leg 120, arm 130, and/or arm 140 across different embodiments (or across a single embodiment).

Still referring to FIG. 2, but now in combination with FIG. 3, the torso 102 may, either independently or in combination with one or more of the foregoing appendages, provide an internal compartment that can house various electronic computing and/or electronic components, such as control circuitry, tag readers, and effects modules (e.g., one or more speakers and/or one or more lights). For example, in the depicted embodiment, computing components (e.g., a processor, communications module, and memory) of the smart figurine 100 are included in the torso 102, a first tag reader 135 is disposed in hand 134, and second and third tag readers 145, 155 are disposed in the torso 102, with tag reader 145 oriented forwardly (outwardly from the front 104 of torso 102) and tag reader 155 oriented backwardly (outwardly from the back 150 of torso 102).

Notably, hand 134 may be flared so that it can grasp accessories and/or playset features (or other items) and bring these items into close proximity with reader 135. Meanwhile, hand 144 may be closed, or partially closed, to encourage a user to use hand 134 for interactions. However, other embodiments may have other hand positions and/or different tag reader locations, such as within a leg and/or foot, e.g., to allow interactions to be initiated with kicking actions, by standing in certain locations, etc.

Tag readers 145, and 155 may be directly coupled to computing components disposed in the torso 102 (e.g., mounted on the same printed circuit board), but reader 135 (as well as any other readers included in any other appendages) may be connected to computing components disposed in the torso 102 via wires that extend along wire paths defined in the appendages. The wired connections may provide an operative connection while still allowing flexibility/articulation of the appendages about the torso 102 and/or joints included therein (e.g., elbow 132). Additionally, a battery compartment may be provided in one or more of the appendages (e.g., leg 110 and/or leg 120) to provide power to any computing/electrical components of the toy figurine 100. In at least some embodiments, separate appendages are used for tag readers and battery components to avoid complications in wire routing.

As is shown in FIG. 3, in at least some embodiments, the back 150 of the torso 102 may include a port 152 for charging and/or transmitting data to internal components (e.g., a micro-USB port), an actuator 154 for activating the toy figurine 100 (e.g., an on/off and/or volume switch), and an indicator 156 to provide indications relating to operations of the internal components (e.g., indications as to whether an update is successful, whether a tag has been read, and/or battery status). However, the port 152, actuator 154, and indicator 156 are merely examples, and a smart figurine 100 could include any combination of components, in any location, to allow interaction with and/or to provide indications relating to operations of components included within the smart figurine 100. Moreover, figurine 100 is only one example of a smart or “primary” toy that may be included in the interactive toy system presented herein and, in other embodiments, any other toy could include similar features (e.g., a plush, a figurine of different proportions, an animal figurine, etc.).

Now turning to FIG. 4, at a high-level, the computing components included in a smart toy 160, such as figurine 100, of the interactive toy system presented herein may include control circuitry 170 with a processor 172, a memory 174, and a communications module 173. The control circuitry 170 may be coupled to one or more effects modules 180-180(X) and one or more tag readers 190-190(X). The one or more effects modules 180-180(X) are or include components configured to generate lights, sounds, and/or motion, such as speakers, lights, light arrays, motors, etc. Meanwhile, the one or more tag readers 190-190(X) may include NFC and/or RFID readers that can read NFC and/or RFID tags. The control circuitry 170, the effects modules 180-180(X) and the tag readers 190-190(X) may be powered by a battery module 168, which may be a battery compartment with replaceable batteries and/or a rechargeable energy source. The battery power should be sufficient to excite/energize the one or more tag readers 190-190(X) while also powering the control circuitry 170 and the effects modules 180-180(X).

More specifically, the tag readers 190-190(X) may be or comprise inductive coils that can transmit power signals and/or data signals between a smart toy (e.g., a powered toy) and another component of the interactive toy system, such as an unpowered accessory. Preferably, the inductive coils are formed within a toy, e.g., as part of a toy figurine. The inductive coils, when properly located and oriented, can receive or transmit signals without direct contact between the powered device and the unpowered component, creating magical and fun play patterns. The inductive coils function as an inductive bridge between components, and enable effects that surprise and/or reward users. The inductive bridge may also enable updates, as is described in more detail below.

For the purposes of this application, powered inductive coils may be referred to as “readers” while inductive coils intended to communicate with powered inductive coils may be referred to as “tags.” Readers may be any Near Field Communications (NFC) or Radio Frequency Identification (RFID) device that generates an electro-magnetic (EM) radio-frequency (RF) field that can provide power to a target coil/tag and/or receive data from a target coil/tag. That is, a “reader,” as used herein, may be or include an NFC or RFID transceiver. For example, a reader may be an inductor, e.g., a coiled conductor that converts an electrical signal to an EM RF field and vice versa. That is, a “reader” may function as a directional antenna and, thus, may be carefully located within a smart toy, such as a figurine.

Generally, inductive communication via wireless technologies, such as NFC or RFID uses directional transceivers. Such communication generally works only over short distances, e.g., up to a few centimeters. NFC and RFID further may require a particular alignment and a close proximity between the communicating devices. The interactive toy system presented herein orients transceivers (i.e., “tags” and/or “readers”) in locations that allow power or data exchange during play patterns. For example, in figurine 100 of FIGS. 2 and 3, reader 135 provides a directional antenna configured to direct a field in a direction dictated by the orientation of the palm of hand 134 while readers 145 and 155 provide directional antennae configured to direct fields forward and rearward of torso 102.

When a smart toy's reader is coupled to another inductor, e.g., a “tag” of a dumb or semi-dumb component of the interactive toy system, the smart toy can supply power and/or data to the tag and/or receive power and/or data from the tag. The tag may be any NFC- or RFID-compatible device that receives power from and/or returns data to a “reader,” such as an NFC or RFID transducer, sticker, or chip that may package a coil, communications system, and/or memory as a unit. Thus, when a tag is interrogated by a reader, the tag may deliver stored data to the reader. Moreover, a “tag” may include a coiled conductor that converts an EM RF field to an electrical signal. The interactive toy system may leverage this power transfer with “semi-dumb” components, which, in some embodiments, may also comprise a power source, and/or a powered device connected to the tag.

The number of turns in a coil used as a reader or tag, its dimensions, and other properties may be selected to match an applicable NFC or RFID frequency and/or standard. Moreover, coils serving as “readers” or “tags” can be manufactured by various techniques including circuit printing techniques and can have associated electronic parts, e.g., capacitors and/or resistors, e.g., to tune the response.

The memory 174 may store tag logic 176, which may be executed by the processor 172 to identify a tagged component brought into proximity with one of the tag readers 190-190(X) and to select an effect for the effects modules 180-180(X) to generate based on the same. That is, the tag logic 176 may allow the smart toy 160 to identify another toy (e.g., an accessory, playset, etc.) that a user is playing with. Additionally, the memory 174 may store operational logic 178 that may allow the processor 172 to operate and/or monitor various sensors/equipment included in the toy 160, such as tag readers 190-190(X) and effects modules 180-180(X).

As is explained in further detail below, when a tag reader of tag readers 190-190(X) reads a tag, the processor 172 may execute tag logic 176 to select one or more effects to generate. In some embodiments, this selection is based on information stored in tag table 1761, which may associate/correlate effects with tags and/or tag readers. The tag table 1761 can be maintained in local memory and/or an electronic device that is connected to the smart toy 160 via communications module 173 (e.g., a device executing an application associated with the interactive toy system presented herein). The tag table 1761 may also be updated based on data received from an update tag read by a tag reader and/or data received via communications module 173 (e.g., via a wired connection via port 152).

More specifically, memory 174 may include random access memory (RAM) or other dynamic storage devices (i.e., dynamic RAM (DRAM), static RAM (SRAM), and synchronous DRAM (SD RAM)), for storing information and instructions to be executed by processor 172. The memory 174 may also include a read only memory (ROM) or other static storage device (i.e., programmable ROM (PROM), erasable PROM (EPROM), and electrically erasable PROM (EEPROM)) for storing static information and instructions for the processor 172. Although not shown, the toy 160 may also include a bus or other communication mechanism for communicating information between the processor 172 and memory 174.

Additionally, although FIG. 4 illustrates processor 172 as a single box, it should be understood that the processor 172 may represent a plurality of processing cores, each of which can perform separate processing. The processor 172 may also include special purpose logic devices (i.e., application specific integrated circuits (ASICs)) or configurable logic devices (i.e., simple programmable logic devices (SPLDs), complex programmable logic devices (CPLDs), and field programmable gate arrays (FPGAs)), that, in addition to microprocessors and digital signal processors may individually, or collectively, are types of processing circuitry.

The processor 172 performs a portion or all of the processing steps required to execute instructions contained in memory 174 and/or received at communications module 173. Such instructions, or at least a portion thereof, may be read into memory 174 from another computer readable medium (e.g., an update tag). One or more processors in a multi-processing arrangement may also be employed to execute sequences of instructions contained in memory 174. In alternative embodiments, hard-wired circuitry may be used in place of or in combination with software instructions. Thus, embodiments are not limited to any specific combination of hardware circuitry and software. Put another way, the toy 160 includes at least one computer readable medium or memory for holding instructions programmed according to the embodiments presented herein and for containing data structures, tables, records, or other data described herein.

Still referring to FIG. 4, the communications module 173 provides a two-way data communication coupling to a network, such as a local area network (LAN) or the Internet. The two-way data communication coupling provided by the communications module 173 can be wired (e.g., via data port 152) or wireless. Moreover, in some embodiments, the two-way communication may allow the toy 160 to communicate with other pieces/components of the interactive toy system presented herein (as is described in further detail below) and/or may allow the toy 160 to communicate with an electronic device that is coupled to the interactive toy system (e.g., via a wired connection between an electronic device and data port 152 and/or via a wireless connection). That is, communication module 173 may include any hardware or software appropriate for implementing wireless data transfer according to a selected NFC or RFID standard, such as one or more integrated circuits that generate, receive, and process NFC or RFID signals.

To be clear, although a personal electronic device (e.g., phone, tablet, etc.) is not shown in FIG. 4, the toy 160 can connect to any personal electronic device, including portable electronic devices like smartphones, tablets, and laptops running a variety of operating systems (e.g., iOS, Android, etc.), as well as desktops or other computing device that require wired power. However, in many embodiments, such a connection will be unnecessary since updates and communications may be transmitted through tag-to-tag communications.

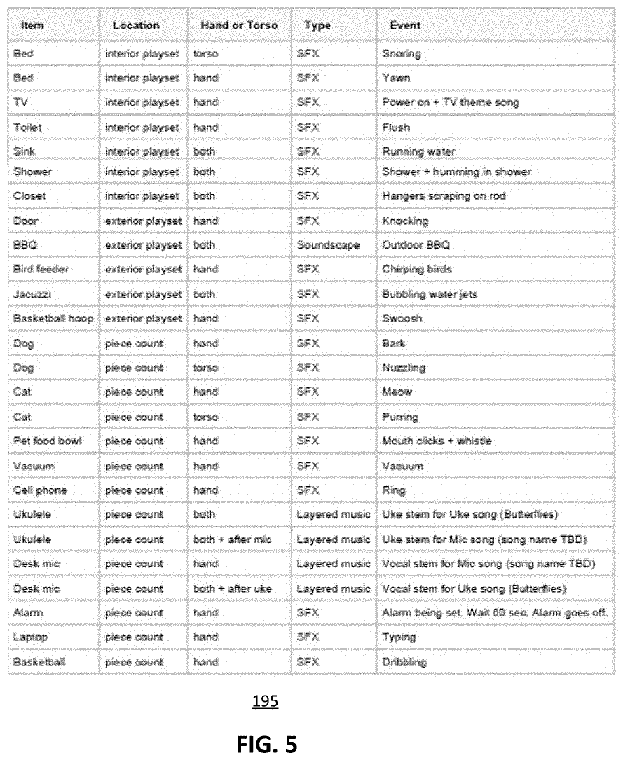

Now turning to FIG. 5, this Figure illustrates an example set of data 195 that may populate a tag table 1761 stored in memory 174. In this example embodiment, the smart toy is a figurine with a tag reader in its hand and one or more tag readers in its torso (e.g., figurine 100). Additionally, in this example embodiment, each tag included in an interactive toy system is identified with an “item” name, such as a bed, toilet, bird feeder, dog, car, ukulele, desk mic, etc. and with its location, which is selected from “interior playset,” “exterior playset,” or “piece count.” The location indicates whether the tag is included in a playset or a stand-alone accessory (“piece count”). As can be seen, the table associates different effects with each tag, but at least some effects are dependent on the specific tag reader reading the tag.

For example, if a torso tag reader reads the “bed” tag, a processor in the toy figurine may cause a speaker to produce a first sound effect (snoring). But, if the hand tag reader reads the “bed” tag, the processor in the toy figurine may cause a speaker to produce a second sound effect (yawn). By comparison, if either the hand or a torso tag reader reads the “shower” tag, the processor in the toy figurine may cause a speaker to produce a first sound effect (running water). Still further, if the hand tag reader reads the “toilet” tag, the processor in the toy figurine may cause a speaker to produce a first sound effect (flush), but the processor may not generate any sound effects if a torso reader reads the “toilet” tag (there is no data entry in table 195 associated with the “toilet” tag and a torso reader). Put another way, in this embodiment, the toy figurine may only cause a speaker to produce a sound effect if a specific tag reader reads a specific tag.

Still referring to FIG. 5, in at least some embodiments, at least some tags may be associated with layered effects. For example, tags in musical accessories may be associated with layered effects that can layer on top of each other, such as different components or “layers” of a song (e.g., the arrangements of a song for a particular instrument). If the tag readers in the toy figurine read tags associated with layered effects, the figurine may build different layered effects, depending on the sequence in which the tags are read. In such embodiments, the first layered tag of a sequence may determine the layered effect (e.g., the song stem) and subsequent layered tags of a sequence may add layers to this layered effect.

As a specific example, if a torso reader or the hand tag reader reads the “ukulele” tag, a processor in the toy figurine may cause a speaker to start playing the ukulele stem of a fist song (e.g., “butterflies”). Then, if the torso or hand reader reads the “desk mic” after reading the “ukulele” tag, the processor may cause the speaker to play the ukulele stem of the first song with lyrics. By comparison, if the hand reader reads the “desk mic” before reading the “ukulele” tag, the processor may cause the speaker to play lyrics of a second song and may add a ukulele accompaniment if the “ukulele” tag is read by any of the readers during the course of the second song. However, to be clear, the foregoing layered effects are merely examples and in other embodiments, any desirable effects can be layered in any manner (e.g., singing over a shower, lights added to sound, sound added to lights, sound added to motion, light added to motion, etc.)

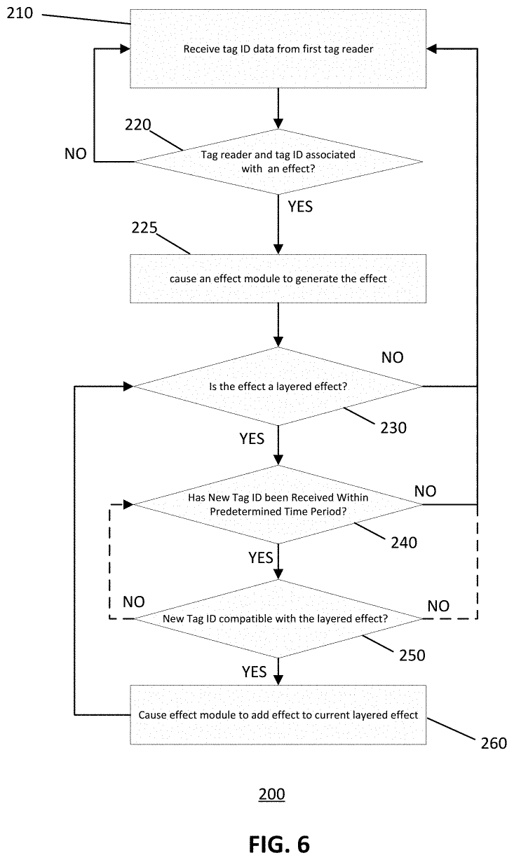

Now turning to FIG. 6, this figure illustrates a method 200 that may be executed by computing components included in a smart toy of the interactive toy system presented herein, such as toy 160 of FIG. 4 and/or smart figurine 100 of FIG. 2. For simplicity, method 200 is described as being executed by a processor, such as processor 172. However, this description is not intended to be limiting in any way and it should be understood that method 200 can be executed by any desirable computing and/or electrical components.

That said, at 210, a processor receives a tag identity (“ID”) from a first tag reader. The tag ID can be numerical, alpha-numerical, a string, or any other data representative of the tag. Likewise, the tag reader from which the tag ID was received can be identified in any desirable manner (e.g., with a numbering system). Regardless of the data type, upon receiving the tag ID and the tag reader, the processor can determine if the tag ID and/or the tag reader are associated with an effect at 220. If so, the processor can cause an effect module, such as a speaker, light unit, and/or mechanical motion system, to generate an effect at 225, such as a sound effect, a light effect, and/or a movement. As was described above, a first combination of a tag ID and a tag reader may result in the processor causing the effects module to generate a first effect while a second combination of a tag ID and a tag reader may result in the processor causing the effects module to generate a second effect. Additionally, some combinations of tag IDs and tag readers may not generate any effects.

After, concurrently with, or even before causing the effects module to generate an effect at 225 (the order of the flow chart depicting method 200 is not necessarily representative of the order of operations executed by a processor executing method 200), the processor may determine if the effect is a layered effect at 230. If not, the processor may revert to step 210 (e.g., wait for a next tag ID). However, if the effect is a layered effect, the processor may analyze new tag IDs to determine if layers should be added to the layered effect. Specifically, at 240, the processor may determine if a new tag ID has been received within a predetermined time period, which, for example, could be the length of a song that has been selected as the layered effect.

Notably, while some tags may be associated with non-layered effects, those tags may also be associated with a layered effect that can only be accessed when another layered effect is playing. For example, if a cat accessory is read independent of any other accessories, the smart toy may produce cat sounds, but if the cat accessory is read after a musical accessory associated with a layered effect, the cat accessory may add a “cat layer” to the layered effect (e.g., a cat “singing”). Thus, in at least some embodiments, the determination at 230 may be dependent on the prior steps of method 200 (e.g., dependent on which effect is produced at 225).

If a new tag ID is received within the time period set at 240 (from a tag reader configured to read tags), the processor determines, at 250, if the new tag ID is compatible with the layered effect. That is, the processor determines, at 250, if the new tag ID can add a layer or effect to the layered effect currently being generated. If the new tag ID is compatible with the layered effect, the processor causes the effect module to either add a layer to the current effect or add an effect to the current effect at 260. The former option (adding a layer) creates or further enhances a multi-layer effect. For example, the processor can determine, at 250, that a new tag adds an instrumental layer to a song being played and can instruct the effect module to add the instrumental layer at 260. The latter option (adding an effect) may add a disruption or non-synchronized noise (e.g., a cat meowing during a song) at 260 but may create continuity of play (since accessories are still recognized).

Put another way, in some embodiments, if the new tag ID received at 240 is not associated with a new layer of the currently generated layered effect, the processor may still determine that the new tag ID is compatible with the currently generated layered effect. Then, the processor may cause the effect module to add an effect to the current layered effect at 260. For example, a dog bark sound effect may play while a layered song plays (with any layers previously added). Meanwhile, if the compatible tag ID adds another layer to a layered effect, the multi-layer effect may be governed (e.g., selected) based on the first tag ID of a sequence, while subsequent tag IDs add layers in an order that matches the order of tag readings, as discussed above. Additionally or alternatively, in some embodiments, the specific layers added to a multi-layer effect may be based on the tag reader at which a tag ID was read, thereby providing a wide variety of multi-layer effects for a user to explore.

However, if the new tag ID is not compatible with the layered effect, there are multiple options for proceeding, as is shown by dashed lines. In some instances, the processor can ignore the new tag ID and revert to 240, e.g., to continue waiting for new tag IDs that are compatible with the layered effect during the predetermined time period. Alternatively, in some embodiments, the processor may exit the layered effect loop (e.g., 230, 240, 250, and 260) and play an effect associated with the new tag ID, either immediately or at the end of the predetermined time period (e.g., after a song has finished). In at least some instances, different rules may be associated with different tag IDs to govern processor operations when a new tag ID is not compatible with a currently generated layered effect (e.g., finish effect prior to continuing, interrupt if specific tag IDs are read, etc.).

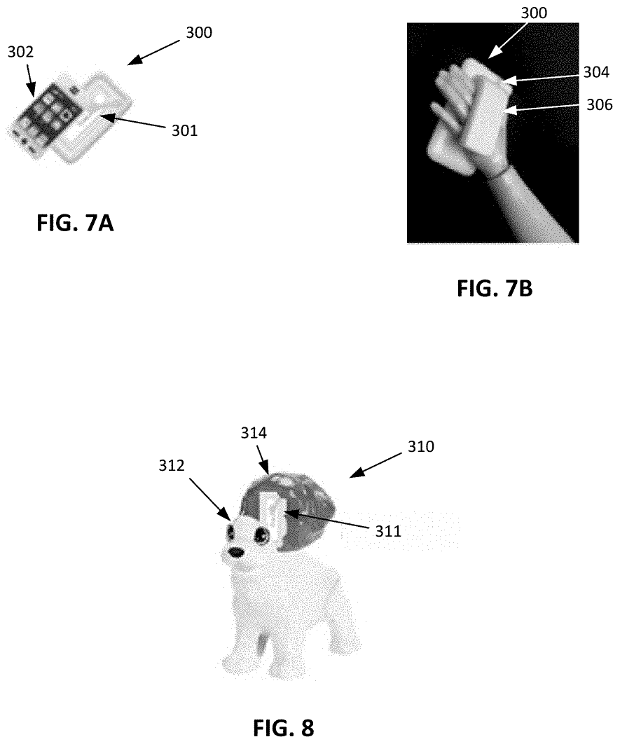

Now turning to FIGS. 7A, 7B, and 8-11, these Figures illustrate accessories that can be included in the interactive toy system presented herein. Each of these example accessories is a “dumb” or “semi-dumb” accessory; however, again, these are only examples. First, in FIGS. 7A and 7B, the first accessory 300 resembles a smart phone and includes a tag 301 disposed between a front 302 and a back 304 of the first accessory 300. More specifically, the tag 301 is arranged parallel to the front 302 and the back 304. In at least some embodiments, the front 302 is a sticker that simply covers the front of the tag 301. Alternatively, the front 302 could be a part or component (e.g., molded plastic). Either way, the back 304 of the first accessory 300 includes a clip 306 that allows the first accessory 300 to sit in a hand of a toy figurine (e.g., hand 134 of figurine 100 of FIG. 2) and, thus, can align the tag 301 with a tag reader disposed in a palm of the hand. Additionally, if the first accessory 300 is clipped to a hand on an articulable arm, the clip 306 may position the first accessory 300 so that movement of the hand towards the torso brings the first accessory 300 into range of a tag reader in a front of the torso of the figurine.

Second, FIG. 8 illustrates a second accessory 310 with a second tag 311. The second accessory 310 resembles a dog and the second tag 311 is disposed between a front head portion 312 and a back head portion 314, which are exploded in FIG. 8 to show the second tag 311. Thus, the second tag 311 can be read when a figurine interacts with the dog accessory 310 in a natural manner, such as by petting the dog (bringing the second tag 311 into proximity of a hand reader) or hugs the dog (bringing the second tag 311 into proximity with a torso reader). To be clear, FIGS. 7A, 7B, and 8 are merely examples; however, generally, accessories of the interactive toy system may include tags that are positioned to facilitate natural interactions with the accessories. That is, accessories of the interactive toy system may include tags that can be read when the accessories are in natural play positions with respect to a smart toy of the interactive toy system (as opposed to requiring accessories to be moved to a specific sensor position before being placed into a play position).

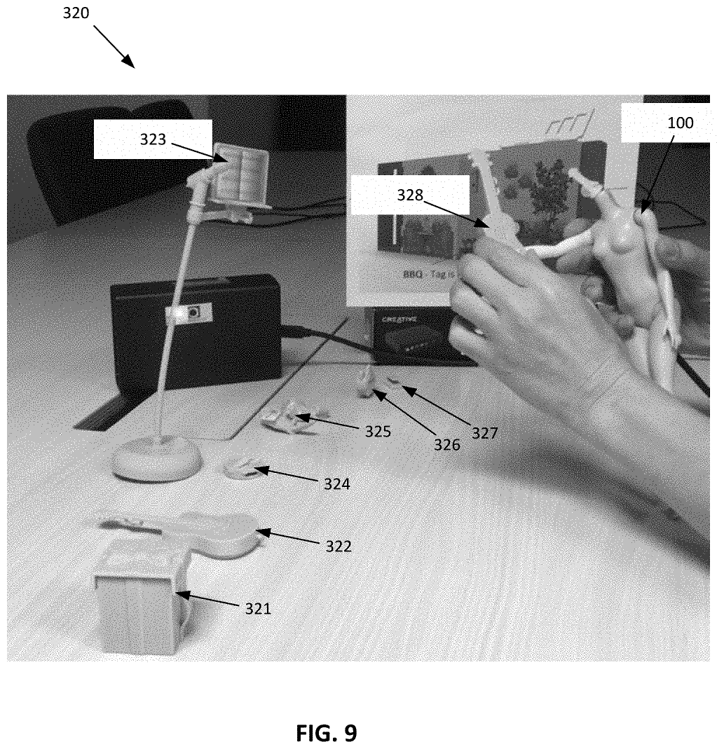

Next, FIG. 9 illustrates a first accessory set 320 including eight tagged accessories: a first accessory 321 that resembles a present, a second accessory 322 that resembles a guitar, a third accessory 323 that resembles a microphone and music stand, a fourth accessory 324 that resembles a tambourine, a fifth accessory 325 that resembles shoes, a sixth accessory 326 that resembles an alarm clock, a seventh accessory 327 that resembles a phone (like first accessory 300), and an eighth accessory 328 that resembles a ukulele. Although not shown, the tags of each of these accessories are positioned to be read when the accessories are in natural play. For example, the second accessory 322 and the eighth accessory 328 may include tags at back central portion that can be read when the instruments are positioned across the chest of a figurine (a natural guitar/ukulele position). Additionally, at least some of these accessories may be associated with layered effects and, thus, can moved into proximity with a toy figurine (e.g., smart figurine 100) to create a song with different instrumental layers (i.e., stems) in the manner described above (e.g., in connection with method 200).

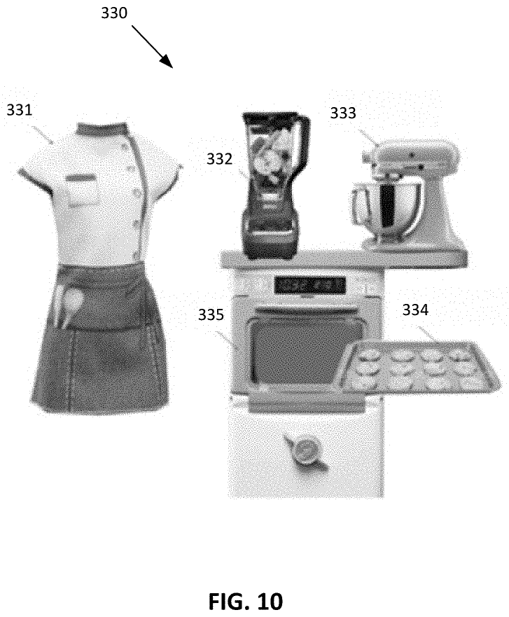

FIG. 10 illustrates a second accessory set 330 that could, for example, be sold separately from the first accessory set 320. The second accessory set 330 includes a first accessory 331 in the form of clothing, a second accessory 332 that resembles a blender, a third accessory 333 that resembles a stand mixer, a fourth accessory 334 that resembles a baking sheet with cookies, and a fifth accessory 335 that resembles an oven. However, importantly, since the accessories in the second accessory set 330 are all different from the accessories in the first accessory set 320, the accessories in the second accessory set 330 will have different tags than the accessories in the first accessory set 320.

In some embodiments, a smart toy may only be able to recognize accessories included in a first set of accessories (e.g., a set of accessories with which it is sold or for which it is intended). Thus, in the depicted embodiment, the first accessory 331 is an update accessory that includes an update tag configured to update the control circuitry of the smart toy of the interactive toy system (e.g., to update the tag table 1761). After the update is applied, the smart toy may be able to recognize all of the tags included in the second accessory set 330 (in addition to the tags included in the first accessory set 320) and associate one or more effects with each of these tags.

Again, although not shown, the tags of each of the accessories in the second accessory set 330 are positioned to be read when the accessories are in natural play positions (e.g., when a toy figurine grasps the accessories in a manner appropriate for cooking). Additionally, some of the second accessory set 330 may be semi-dumb accessories that include effects modules that can be activated by the smart toy. For example, the second accessory 332 and/or the third accessory 333 may include a motor that spins a portion of the accessory when the tag is brought into proximity with a tag reader of the smart toy (e.g., to create motion and/or activate a smoke/bubble machine). More specifically, the tag reader may be a coil that transfers power to a coil in the accessory to power a motor included in the accessory.

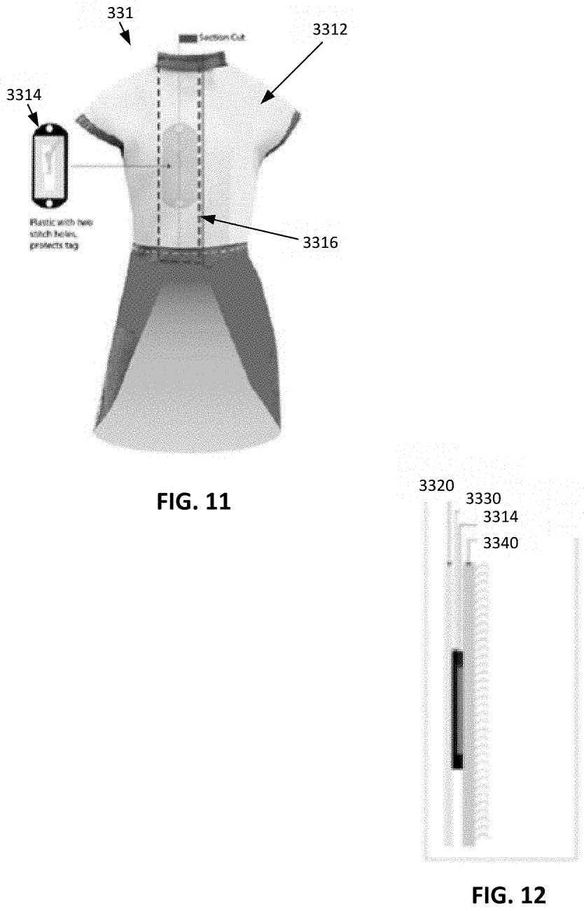

Now turning to FIGS. 11 and 12, the update accessory 331 may be specifically designed to align a tag with a larger amount of data (e.g., more data than tags that only store a tag ID) to the computing components of a smart toy. Specifically, in the depicted embodiment, the update tag 3314 is positioned within a pocket 3316 that is positioned along a center of a back 3312 of the clothing accessory 331. This positioning may align the update tag 3314 with a tag reader on a back of the torso of a smart figurine (or any other reader of a smart toy). As can be seen in FIG. 12, the pocket 3316 may be formed by a plastic housing 3330 disposed between an exterior layer 3320 and a hook and loop fastener layer 3340. The plastic housing 3330 can secure and protect the update tag 3314 while the hook and loop fastener layer 3340 can secure the tag 3314 in place against a tag reader on the smart toy. The exterior layer 3320 can cover the entire assembly so that the accessory 331 has the appearance of a traditional/conventional doll accessory.

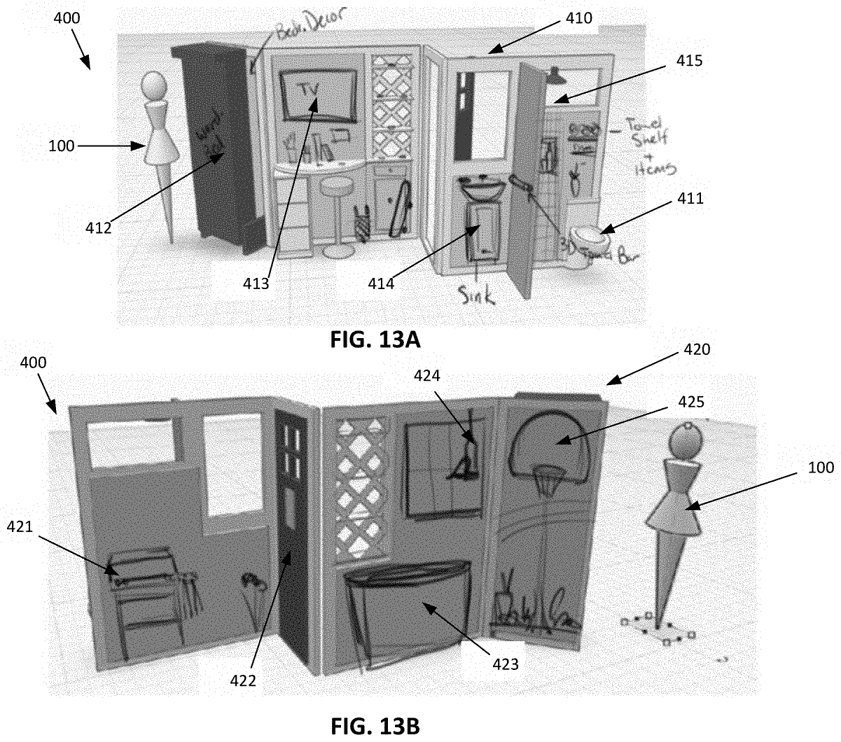

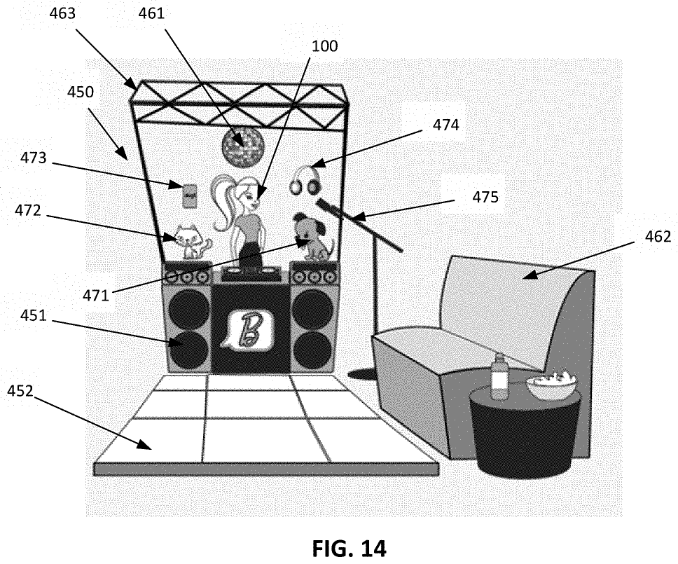

Now turning to FIGS. 13A, 13B, and 14, these figures depict playsets that can be included with the interactive toy system presented herein. First, FIGS. 13A and 13B illustrate interior and exterior views of a first playset 400. The interior side 410 of playset 400 includes five tagged features: a first feature 411 resembling a toilet, a second feature 412 resembling a bed, a third feature 413 resembling a television, a fourth feature 414 resembling a sink, and fifth feature 415 resembling a shower. The exterior side 420 of first playset 400 also includes five tagged features: a sixth feature 421 resembling a grill, a seventh feature 422 resembling a door, and eighth feature 423 resembling a hot tub, a ninth feature 424 resembling a bird feeder, and a tenth feature 425 resembling a basketball hoop.

Like the accessories discussed above, each of features 411-415 and 421-425 may be tagged in a location to allow the tags to be read by tag readers in an appendage or torso of a figurine during natural play patterns. For example, touching a hand to a toilet tank of feature 411 may cause the smart figurine to generate a flushing sound. Likewise, touching a hand to the bird feeder of feature 424 may cause the smart figurine to generate bird tweets/sounds. Additionally, in some embodiments, the playset may include electronics to allow the playset to generate sounds, lights, motions, etc. That is, the playset may be “semi-dumb.” For example, feature 414 (the sink) and/or feature 415 (the shower) may include bubble machines with motors that can receive power from a smart toy that causes the motor to rotate and generate bubbles. Likewise, feature 421 (the grill) could include a smoke machine with a motor that can receive power from a smart toy that causes the motor to rotate and generate smoke.

Still further, in some embodiments, feature 413 may be able to show video content, such as a movie or webisode/episode associated with a smart figurine, or at least trailers or snippets of such video content, to allow cross-promotion of brand content in a playset. In fact, in some embodiments, the playset could be a smart playset with computing components (e.g., components similar to those described above in connection with FIG. 4) that are able to receive updates from tagged accessories, for example, to update video, images, and/or audio for feature 413 based on the latest webisode/episode associated with a smart figurine. Advantageously, the update would not require a sophisticated interaction (e.g., a parent interaction) and could be completed via a tag-to-feature update. That is, a user could buy a new accessory to add new content to the playset (or to a smart toy) instead of having to connect the playset to the Internet and/or an app to add new content.

Second, FIG. 14 illustrates another playset 450 that also includes features, but playset 450 may also be a smart playset so that the playset can interact with both smart toys and dumb or semi-dumb accessories included in the interactive toy system. More specifically, playset 450 includes a first smart feature 451 resembling a deejay station and a second smart feature 452 resembling a dance floor. Smart features 451 and 452 may each read tags, including at least tags of accessories included with the playset, and interact accordingly (e.g., like a smart figurine/toy, e.g., as described in connection with FIGS. 4 and 5). In the depicted embodiment, playset 450 includes “dumb accessories” in the form of a first accessory 471 resembling a dog, a second accessory 472 resembling a cat, a third accessory 473 resembling a smartphone, a fourth accessory 474 resembling headphones, and fifth accessory 475 resembling a microphone. Thus, the playset 450 may be able to recognize and interact with each of these accessories and may require an update (e.g., a tag-to-tag update) to recognize and interact with additional accessories.

Additionally, playset 450 may include dumb or semi-dumb features, including a first feature 461 resembling a disco ball and a second feature 462 resembling a bench/seat, and a third feature 463 resembling lights. The dumb or semi-dumb features 461-463 each include tags that, when read, can cause a smart toy to produce an effect and/or to transfer power to features 461-463 to cause the features 461-463 to generate an effect (in the same manner described above in connection with at least playset 400). Additionally or alternatively, smart features 451 and 452 can control the dumb or semi-dumb features 461-463, for example, to coordinate effects between the playset and a toy figurine. As a specific example, the toy figurine 100 might generate sound effects while the dance floor 452 and lights 463 generate light patterns coordinated to the sound effects.

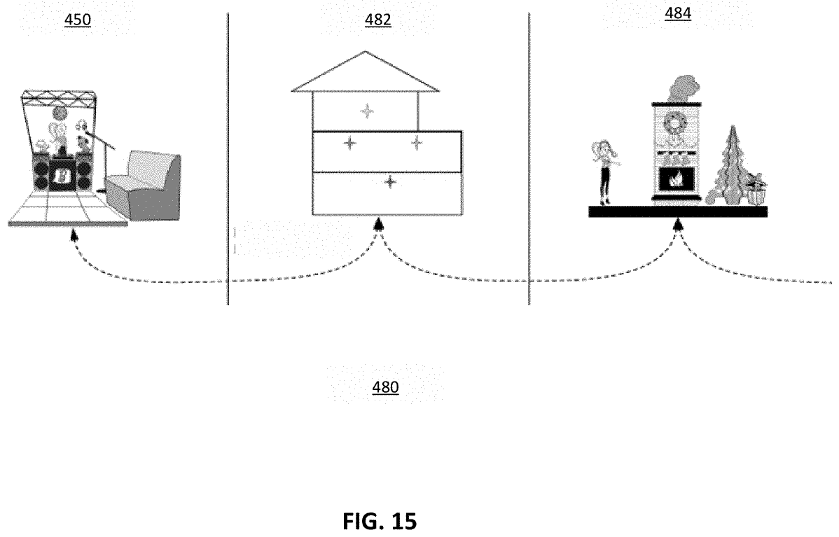

Still further, and now turning to FIG. 15, in some embodiments, playsets could be linked to interact, for example, to coordinate updates. FIG. 15 illustrates this linking at a high-level, with playset 450 being linked to playsets 482 and 484. In some embodiments, linking playsets may, in essence, comprise including an update tag in a playset that provides updates for another playset. For example, if a smart toy has been interacting with playset 450 and is subsequently brought to playset 484, an update tag in playset 484 may update the smart toy to both recognize new features and/or accessories of playset 484 and to create new interactions with features and/or accessories of playset 450. As a more specific example, if playset 484 has a holiday theme, the update tag of playset 484 may update the smart toy to interact with features and/or accessories of playset 484 and to create new holiday-themed interactions with features and/or accessories of playset 450. Additionally or alternatively, smart playsets might include communications modules that allow the playsets to interact directly with each other, for example, to share updates across linked playsets.

However, to be clear, the playsets and accessories shown and described in connection with FIGS. 7A-15 are only examples and, in other embodiments, the toy system herein may include any number of smart, dumb, or semi-dumb components/toys with which the primary smart component of the toy system presented herein can interact. For example, in other embodiments, the toy system may include any number of smart toys/components in any format, such as two smart figurines, and the smart components/toys may include tags that allow the smart toys to interact. As a specific example, a first smart figurine may include a tag that, when activated by a second smart figurine, causes the first smart figurine to produce a first audible effect and causes the second smart figurine to produce a second audible effect that is coordinated with and/or responsive to the first audible effect.

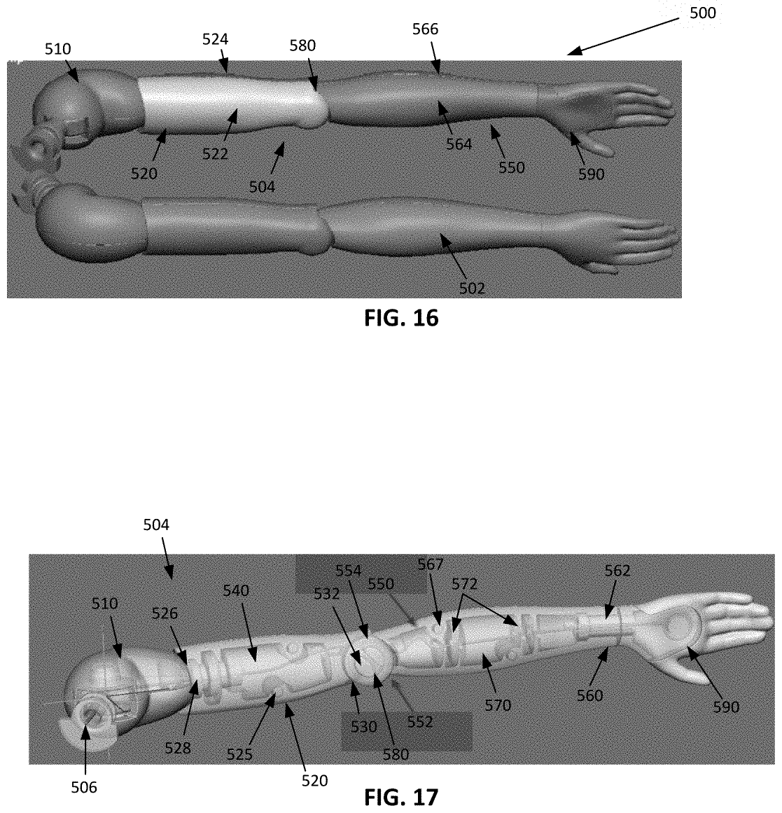

Now turning to FIGS. 16-28, these Figures illustrate three embodiments of wired arms that can be included in a smart figurine, such as figurine 100 of FIG. 2, of the interactive toy system presented herein. Generally, each embodiment provides a wire path that secures a wire within the arm while allowing at least some articulation of the arm. In at least the first two embodiments, the path includes a circular wire path in the elbow, insofar as the term circular wire path is only used herein to denote that a path that is at least partially arcuate, and allows some wire slack to be disposed inside the arm. Thus, during articulation about the elbow, the slack may allow the circular wire path to elongate without stressing or breaking the wire.

However, as is demonstrated by the third embodiment, an arm can also safely connect a hand reader to computing components in a smart toy without a circular wire path. Put generally, the three embodiments are merely examples and, in other embodiments, a wire can be secured within an arm, or any other appendage of a toy or toy figurine in any manner. For example, while the three embodiments of FIGS. 16-28 show an arm path, similar techniques could be used to provide a wire path in one or both legs of a figurine, both arms of a figurine, and/or other features/appendages of a toy (e.g., a tail or other non-human features). That is, although FIGS. 16-28 show arms including tag readers, these Figures are merely examples and smart toys can include tag readers in any desired position (e.g., in legs and/or feet) that are connected to internal electronic/computing components along any desired wire path.

More specifically, FIG. 16 depicts a set of upper appendages 500 including a non-wired arm 502 and a wired arm 504. As implied, the wired arm 504 defines a wire path for a wire that connects a tag reader with computing components included in a central portion of a smart figurine (e.g., within torso 102 of the smart figurine 100 from FIG. 2). Meanwhile, the non-wired arm 502 is an articulable arm without a wire extending therethrough. In the depicted embodiment, the upper arm portion 520 is formed from an inner half 522 and an outer half 524 while the lower arm portion 550 is formed from inner half 564 and an outer half 566. However, this is just an example construction and arm portions 520 and 550 could be formed in any other manner, including by being formed as one or more unitary parts.

Still referring to FIG. 16, but now in combination with FIG. 17, regardless of how the arm portions 520 and 550 are formed, the upper arm portion 520 is connected to the lower arm portion 550 at an elbow joint 580. More specifically, the upper arm portion 520 extends from an upper end 526 to a lower end 530. The upper end 526 includes a socket 528 that connects the upper arm portion 520 to a shoulder 510. The lower end 530 of the upper arm portion 520 includes a connector portion 532 that forms at least a portion of the elbow joint 580. Meanwhile, the lower arm portion 550 extends from upper end 552 to a lower end 560. The upper end 552 of the lower arm portion 550 forms at least a portion of the elbow joint 580 and the lower end 560 of the lower arm portion 550 includes a socket 562 that connects the lower arm portion 550 to a hand 590 that defines a distal end of the wired arm 504.

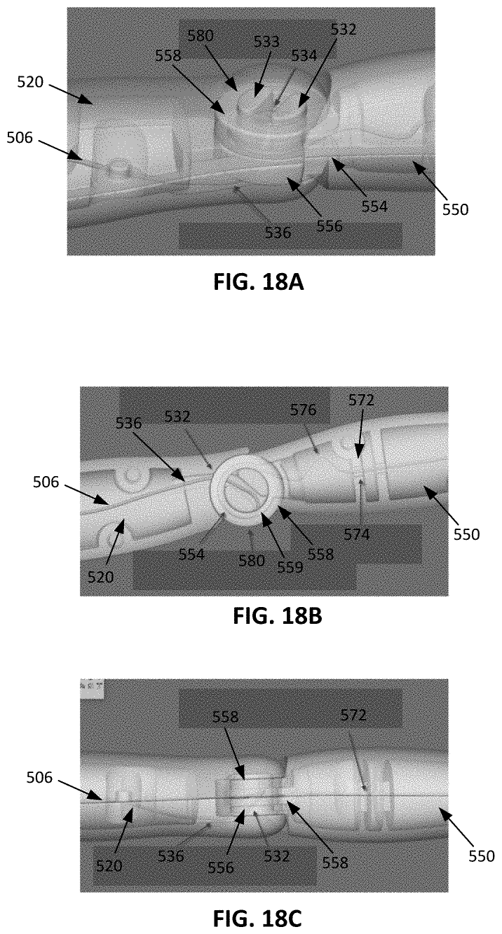

As can be seen in FIG. 17, the arm portions 520 and 550 of wired arm 504 are both at least partially hollow to define a wire path therethrough. In particular, the outer halves 522, 524 of upper arm portion 520 are coupled together to define an interior cavity 540 while the outer halves 564, 566 of lower arm portion 550 are coupled together to define an interior cavity 570. In FIG. 17, mating elements 525 and mating elements 567 illustrate a portion of example features that may facilitate this coupling for upper arm portion 520 and lower arm portion 550, respectively. The interior cavity 540 of the upper arm portion 520 defines a wire path from the upper end 526 of the upper arm portion 520 to the lower end 530 of the upper arm portion 520 while the interior cavity 570 of the lower arm portion 550 defines a wire path from the upper end 552 of the lower arm portion 550 to the lower end 560 of the lower arm portion 550. In the depicted embodiment, the interior cavity 570 also includes struts 572 with guide slots 574 (see FIG. 18B) to more precisely define the wire path within interior cavity 570; however, other embodiments can include more or less struts, in any interior cavity, or need not include any such features.

Now referring to FIG. 17 in combination with FIGS. 18A-18C, the connector portion 532 of the upper arm portion 520 and the connector portion 554 of the lower arm portion 550 are configured to mate with each other in a manner that defines an elbow joint 580 with a circular wire path extending therethrough. The circular wire path is specifically designed to allow articulation of the lower arm portion 550 with respect to the upper arm portion 520 without damaging the wire 506. However, in at least some embodiments, the range of articulation may be limited (e.g., to 90 degrees) to ensure that a wire 506 extending through the elbow joint 580 is not over-stretched and/or over-stressed.

To form such a joint, the connector portion 532 includes a cylindrical boss 533 with a central slot 534. The connector portion 554 of the lower arm portion 550 can be secured onto/around the central slot 534 and, thus, allows the lower arm portion 550 to rotate about the connector portion 532 of the upper arm portion 520. More specifically, in the depicted embodiment, the connector portion 554 of the lower arm portion 550 includes a first annular ring 556 and a second annular ring 558 that are each mounted onto/around the cylindrical boss 533 in stacked configuration. For example, in some embodiments, the cylindrical boss 533 may be included on one of the halves 522, 524 of the upper arm portion 520 and the halves 564, 566 of the lower arm portion 550 may each include one of annular rings 556 and 558. Then, the annular rings 556 and 558 may both be installed onto the cylindrical boss 533 prior to securing the halves 522, 524 of the upper arm together to close the upper arm portion 520.

Regardless of how the elbow joint 580 is formed, the upper arm portion 520 also defines an entry path 536 into the central slot 534. As can be seen best in FIGS. 18A and 18C, the entry path 536 extends below the first annular ring 556, connecting the interior cavity 540 of the upper arm portion 520 to the central slot 534 of the boss 533 (of the upper arm portion 520). Additionally, an upper ring of the annular rings 556 and 558 includes a groove 559 in its bottom surface that is accessible form the central slot 534.

Collectively, the entry path 536, the central slot 534, and the groove 559 define a circular wire path through the elbow joint 580 (as shown in the top perspective, side, and top views of FIGS. 18A-18C, respectively). As can be seen in FIGS. 18A-18C, a wire 506 extending through elbow joint 580 enters the central slot 534 via the entry path 536, beneath the first annular ring 556. Then, the wire 506 extends vertically through the central slot 534 until the wire 506 is above the first annular ring 556 and enters the groove 559 included in a bottom side of the second annular ring 558. The interior of groove 559 is interiorly bounded by the cylindrical boss 533 and, thus, the wire 506 bends around an arcuate path in groove 559 that prevents bending. For the purposes of this application, this arcuate path is sufficient to describe the path as a “circular wire path.”

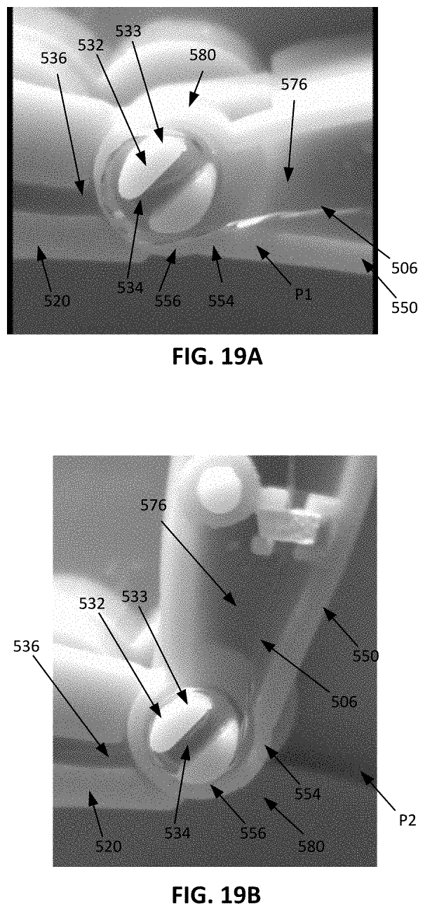

Now turning to FIGS. 18A-18C in combination with FIGS. 19A and 19B, which show a sectional view of the elbow joint 580 while the wired arm 504 moves between a first position P1 and a second position P2, both the central slot 534 and the groove 559 provide room for slack in the wire 506. Additionally, the circular wire path through elbow joint 580 terminates in a slack compartment 576 in the interior cavity 570 of the lower arm portion 550. As can be seen in FIG. 19A (as well as FIGS. 18A-18C), when the wired arm 504 is in a first position P1 (e.g., a straight position), wire slack may collect in the slack compartment 576.

Then, when the wired arm 504 is moved to a second position P2 via articulation of the lower arm portion 550 about the elbow joint 580, the circular wire path may elongate and the slack may be pulled into the elbow joint 580, around the arcuate path defined by the groove 559 and the cylindrical boss 533. This prevents the wire 506 from being stressed or over-tightened during articulation about the elbow joint 580. This also ensures that wired arm 504 provides at least limited articulation while providing a safe and stable electrical connection through wired arm 504.

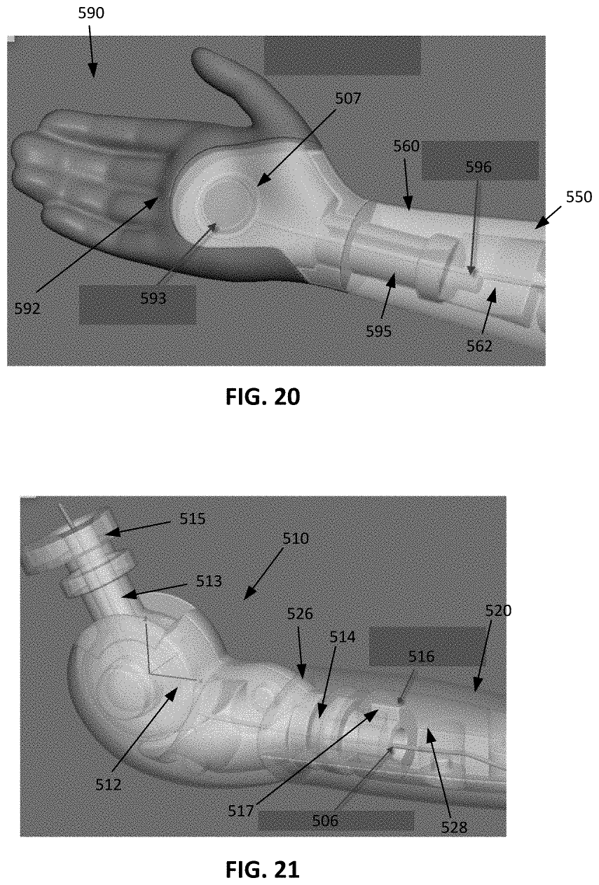

Now turning to FIG. 20, in the depicted embodiment, the hand 590 includes a boss 593 positioned on or towards an inner side 592 of the hand 590. The boss 593 is sized to receive a coil 507 (e.g., NFC ring 507) of the wire 506, which may form at least a portion of a tag reader (as described above). Additionally, the hand 590 may include a connector 595 that can connect the hand 590 to the socket 562 included at the lower end 560 of the lower arm portion 550. In the depicted embodiment, the connector 595 is hollow to define a wire path from the lower arm portion 550 to the hand 590. Furthermore, the connector 595 includes a wrist pin 596 that limits rotation of the hand 590 with respect to the lower arm portion 550, which, in turn, prevents excessive twisting of the wire 506. For example, the wrist pin may limit rotation to a range of 180 degrees. However, in other embodiments, the hand 590 may be connected to the lower arm portion 550 in any desirable manner that defines a wire path and at least partially limits rotation of the hand 590 with respect to the lower arm portion 550.

FIG. 21 illustrates the shoulder 510 included in the wired arm 504. Like the upper arm portion 520 and the lower arm portion 550, the shoulder 510 defines an interior cavity 512 through which the wire 506 may extend. The interior cavity 512 is accessible via an upper tube 513 and a lower tube 514. That is, the upper tube 513 and the lower tube 514 provide conduits with at least enough space for the wire 506 to travel therethrough. The upper tube 513 is included in an upper connector 515 configured to connect the shoulder 510 (and the wired arm 504 as a whole) to a torso of a smart figurine (e.g., torso 102 of the smart figurine 100 from FIG. 2). The lower tube 514 is included in a lower connector 516 configured to connect the shoulder 510 to the upper arm portion 520. Specifically, the lower connector 516 is configured to mate with the socket 528 included in the upper end 526 of the upper arm portion 520 to rotatably couple the shoulder 510 to the upper arm portion 520. However, the lower connector 516 may also include a notch 517 to limit the range of rotation of this coupling and prevent excessive twisting of the wire 506 extending therethrough. For example, notch 517 may limit rotation to a range of 180 degrees.

To be clear, in different embodiments, the wired arm 504 need not include a shoulder 510 that is connected to the upper arm portion 520 via a rotatable coupling. That is, wired arm 504 need not include bicep articulation. Instead, shoulder 510 may be formed as part of upper arm portion 520 and/or may be fixed with respect to the upper arm portion 520. Additionally or alternatively, wired arm 504 need not include a hand 590 that is connected to the lower arm portion 550 via a rotatable coupling. That is, the wired arm 504 need not include wrist articulation. Instead, hand 590 may be formed as part of the lower arm portion 550 and/or may be fixed with respect to the lower arm portion 550. Still further, in other embodiments, the hand 590 and/or the shoulder 510 may be more articulable than the depicted embodiments. For example, the hand 590 and/or the shoulder 510 may be rotatable about more than one axis with respect to upper arm portion 520 and/or lower arm portion 550.

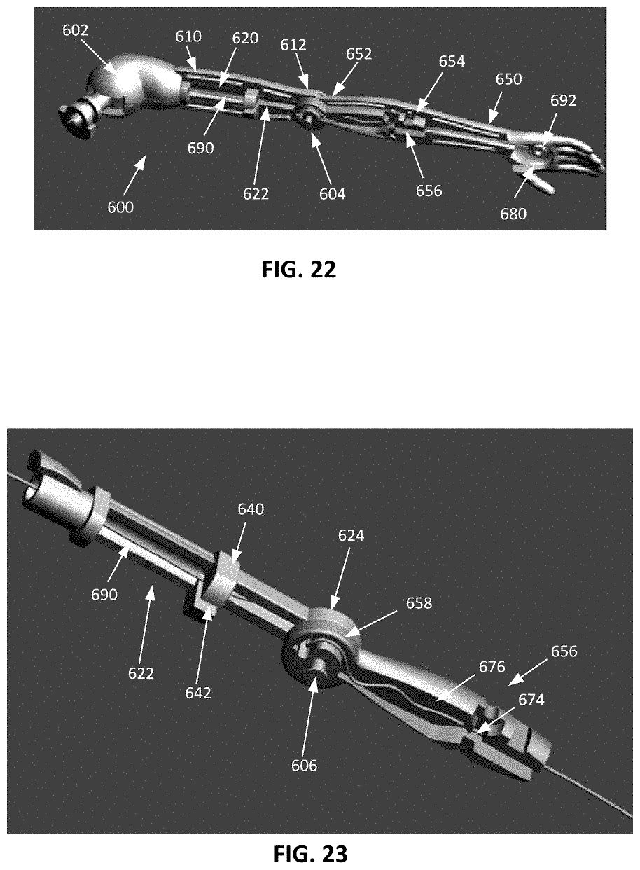

FIGS. 22-24 depict another example embodiment of a wired arm 600 that may be included in a smart figurine of an interactive toy system presented herein. Wired arm 600 has many similarities to the wired arm 504, but for brevity, the similarities are not described in detail below. Instead, the description of wired arm 600 focuses on differences between wired arm 504 and wired arm 600 and any description of like part of these arms included above (e.g., in connection with wired arm 504) should be understood to apply to both wired arm 504 and wired arm 600.

That said, like wired arm 504, wired arm 600 includes an upper arm portion 610 that extends from a shoulder 602 to an elbow joint 604 and a lower arm portion 650 that extends from the elbow joint 604 to a hand 680. Additionally, like wired arm 504, wired arm 600 defines an internal path for a wire 690 that terminates in a coil 692 (e.g., an NFC ring 692) disposed in hand 680.

However, now, the elbow joint 604 is formed by an upper interior element 622 disposed within an interior cavity 620 of the upper arm portion 610 and a lower interior element 656 disposed within an interior cavity 654 of the lower arm portion 650. Interior elements 622 and 656 connect a lower end 612 of the upper arm portion 610 with an upper end 652 of the lower arm portion 650. More specifically, the upper interior element 622 includes a connector portion 624 rotatably connects to a connector portion 658 of the lower interior element 656 while defining a circular wire path therethrough to provide a rotatable, but wired, coupling between the lower end 612 of the upper arm portion 610 and the upper end 652 of the lower arm portion 650.

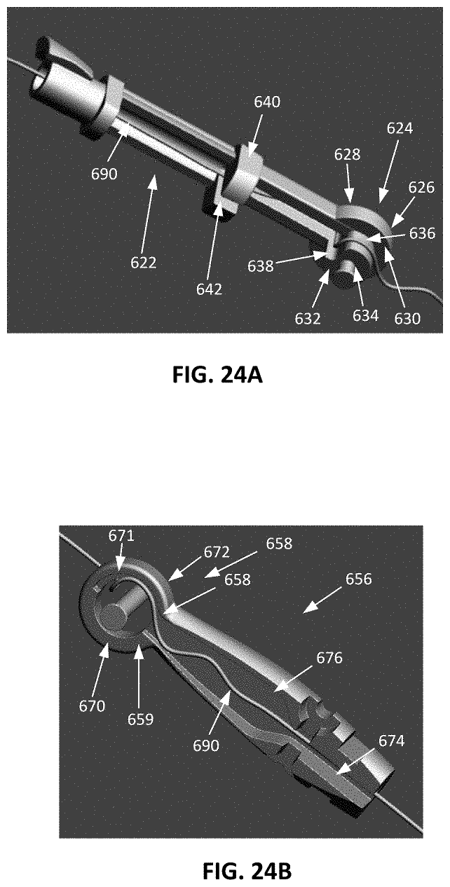

As can be seen in at least FIGS. 23 and 24A, the connector portion 624 includes a rounded plate 626 that extends from an exterior side 628 to an interior side 630. A protrusion 632 extends from the interior side 630. The protrusion 632 includes a center hole 634 and an outer edge with a rounded section 636 and a deflector 638. As is described in further detail below, the deflector 638 may define one end of an arcuate path around the rounded section 636 for a wire 690 passing through elbow joint 604.

On the other hand, as can be seen in at least FIGS. 23 and 24B, the connector portion 658 of the lower interior element 656 includes an annular ring 659 sized to sit on/around the protrusion 632 of the connector portion 624 of the upper interior element 622, against the rounded plate 626. The annular ring 659 extends from an exterior side 670 to an interior side 672 and the exterior side 670 includes a groove 671. As can be seen in FIGS. 24A and 24B, groove 671 is positioned to be substantially aligned with the deflector 638 and the rounded section 636 of the protrusion 632 (of connector portion 624 of the upper interior element 622). Thus, the wire 690 can bend around the rounded section 636 of the protrusion 632 while entering the connector portion 658 of the lower interior element 656. This rounded bend defines a circular wire path, at least for the purposes of this application.

Due to the aforementioned structures, if the lower interior element 656 rotates counter-clockwise about elbow joint 604 (e.g., a direction of natural arm movement), the groove 671 will rotate further over the deflector 638, so that the circular wire path between connector portions 624 and 658 remains open. The circular wire path will also elongate during this counter-clockwise articulation (similar to the circular wire path of wired arm 504) and, thus the wired arm 600 also includes a slack compartment 676 in which slack of wire 690 may be disposed prior to articulation (e.g., bending) of wired arm 600. The slack and circular wire path through elbow joint 604 may ensure that the wire 690 can safely extend through an articulable elbow joint 604. Additionally, in the depicted embodiment, the upper interior element 622 includes struts 640 with guide slots 642 while the lower interior element 656 includes guide slots 674 to help guide the wire 690 through the wired arm 600.

Still referring to FIGS. 22-24, in the depicted embodiment, the upper interior element 622 and the lower interior element 656 are coupled to each other and to outer coverings/halves of the wired arm 600 via a pin 606. The pin 606 defines an axis of rotation for the lower arm portion 650 to rotate about the upper arm portion 610. However, other embodiments need not include pin 606 and can rotate about portions of their connectors. Moreover, in other embodiments, wired arms can include a wire path similar to the wire path or wired arm 600 but need not include interior elements 622 and 656. For example, interior features could be included on inner surfaces of arm coverings/halves (e.g., like wired arm 504). Alternatively, some features might be included on interior elements while other features are included on inner surfaces of arm coverings/halves.

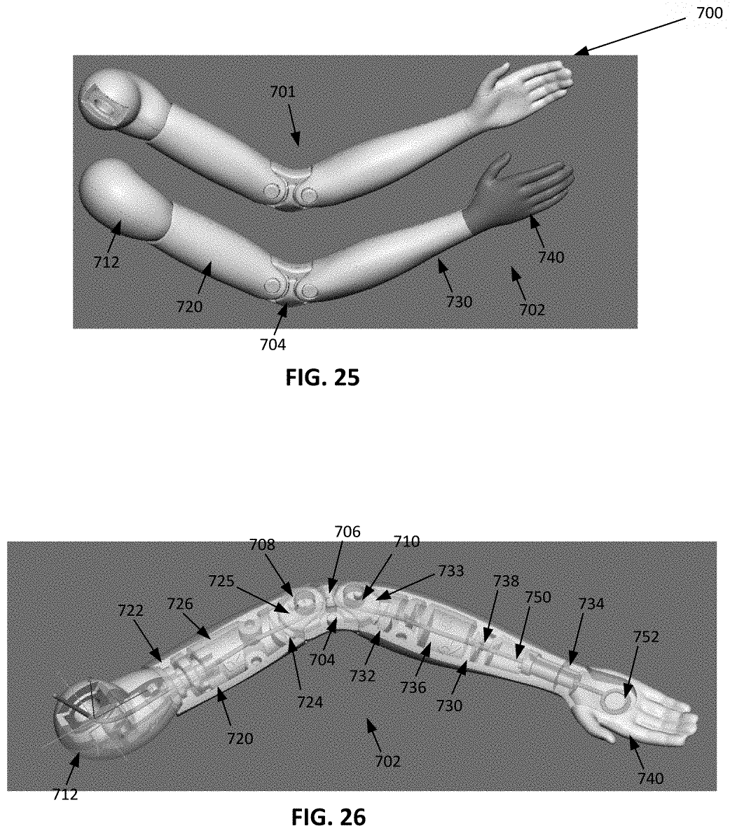

Now turning to FIGS. 25 and 26, these Figures depict another embodiment of upper appendages 700 including a third embodiment of a wired arm 702 and a matching non-wired arm 701. Again, wired arm 702 has many similarities to the wired arm 504 (and wired arm 600), but for brevity, the similarities are not described in detail below. Instead, the description of wired arm 702 focuses on differences between wired arm 504 (and wired arm 600) and wired arm 702 and any description of like parts of these arms included above (e.g., in connection with wired arm 504 and/or 600) should be understood to apply to wired arm 702.

Most notably, wired arm 702 includes an elbow 704 with two joints: a first joint 708 and a second joint 710. The first joint 708 is disposed on one side of an arcuate body 706 and the second joint 710 is disposed on an opposite side of the arcuate body 706. Generally, the elbow 704 connects an upper arm portion 720 to a lower arm portion 730, which in turn, connects a shoulder 712 to a hand 740. More specifically, the upper arm portion 720 extends from an upper end 722 to a lower end 724 and the lower end 724 includes a joint component 725 that forms at least a portion of the first joint 708 of elbow 704. Similarly, the lower arm portion 730 extends from a lower end 734 to an upper end 732 and includes a joint component 733 that forms at least a portion of the second joint 710 of the elbow 704. Upper arm portion 720 and lower arm portion 730 also define interior cavity 726 and interior cavity 736, respectively, to provide wire paths to the elbow 704.

Since elbow 704 has two joints, the lower arm portion 730 does not connect directly to the upper arm portion 720 and, thus, the risk of pinch points forming in the elbow 704 is decreased. Consequently, the elbow 704 of the depicted embodiment does not include a specially defined circular wire path. Instead, the wire 750 passes straight through the first joint 708 and the second joint 710 to provide a connection through the wired arm 702 that extends to the hand 740 to create a coil/NFC ring 752 in hand 740. As shown, the wired arm 702 may still include guide slots 738 in an interior cavity 736 of the lower arm portion 730 that help guide the wire 750 through the wired arm 702, but the elbow 704 itself can be relatively simple and, thus, can eliminate any costs that might be experienced when producing carefully toleranced parts for more complicated paths.

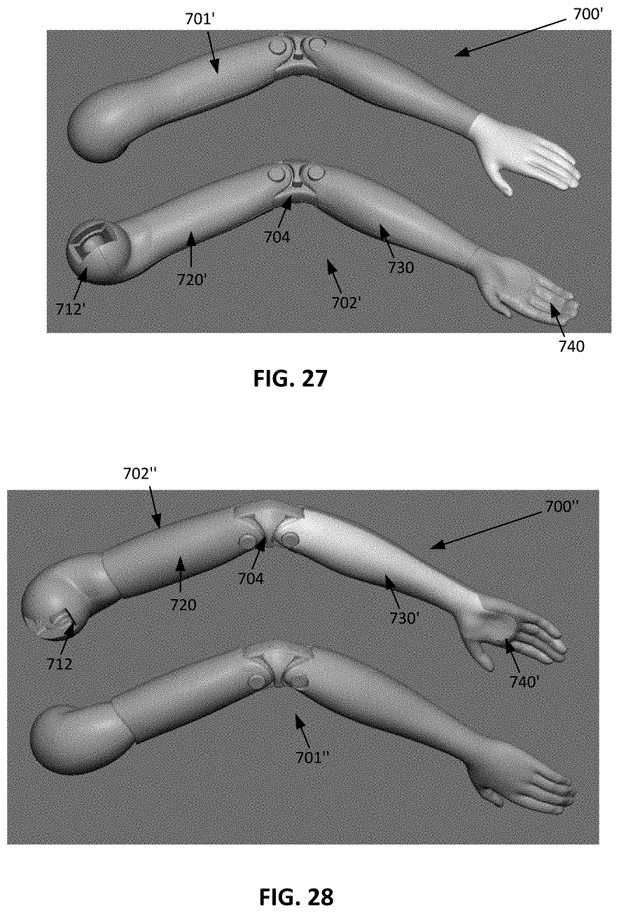

Now turning to FIGS. 27 and 28, as mentioned, in different embodiments, the wired arms presented herein need not include bicep articulation and/or wrist articulation. For completeness, FIG. 27 illustrates an embodiment of appendages 700 without bicep articulation. In this embodiment, appendages 700′ include arms 701′ and 702′ with shoulders 712′ that are formed as part of upper arm portions 720′. By comparison, FIG. 28 illustrates an embodiment of appendages 700 without wrist articulation. In this embodiment, appendages 700″ include arms 701″ and 702″ with hands 740′ that are formed as part of lower arm portions 730′. Again, these are only examples and these examples, combinations thereof, or further variations thereof can be included in any embodiments of the present application.

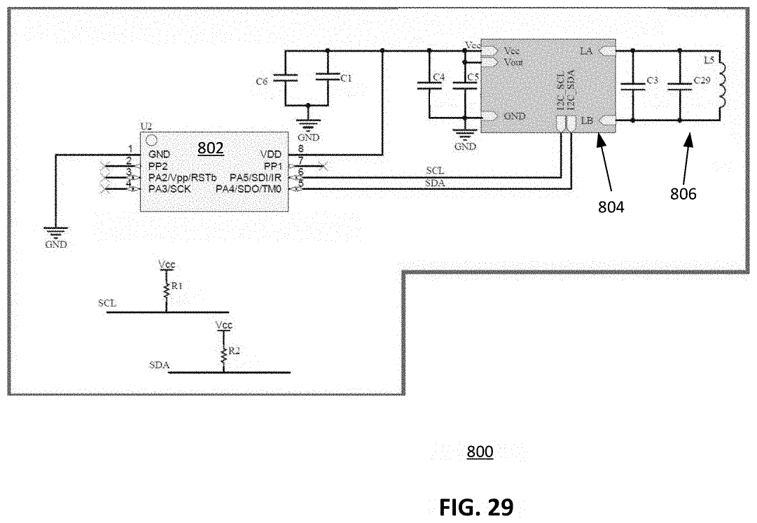

Now turning to FIGS. 29-33, these Figures are circuitry diagrams depicting circuitry that can be included in various components of the interactive toy system presented herein, according to an example embodiment. Specifically, FIG. 29 depicts circuitry 800 that may be used to form an update tag, such as update tag 3314 of FIGS. 11 and 12, for the interactive toy system presented herein. In the depicted embodiment, the update tag circuitry 800 includes a microcontroller 802, such as a 32-bit microcontroller unit (“MCU”) with Serial Peripheral Interface (“SPI”) Flash memory, an NFC bridge 804 and an antenna 806. Thus, the update tag circuitry 800 can store data for an update and for authentication (e.g., a key), as is discussed in further detail below. Generally, the microcontroller 802, NFC bridge 804, and antenna 806 are operable to selectively transmit data to an interactive toy of the interactive toy system presented herein in the manner discussed herein. However, the configuration shown in FIG. 29 is just one example and other embodiments could also include different or additional components interconnected in any desirable manner. For example, the various components of circuitry 900 can be interconnected via pins, example of which are depicted with numbered/named pin notations.

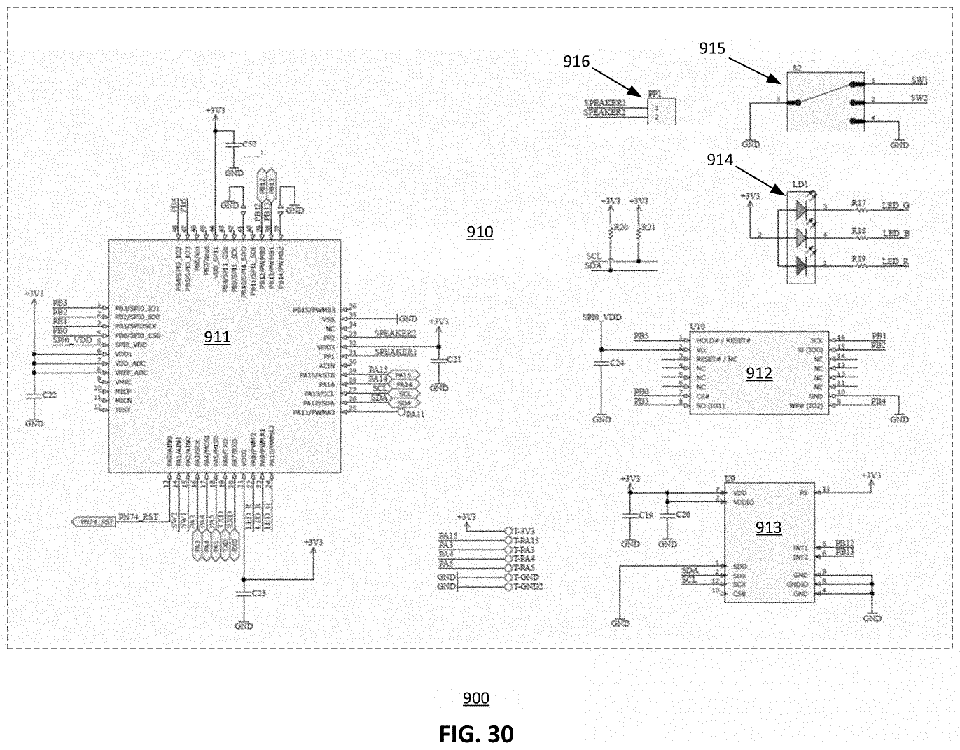

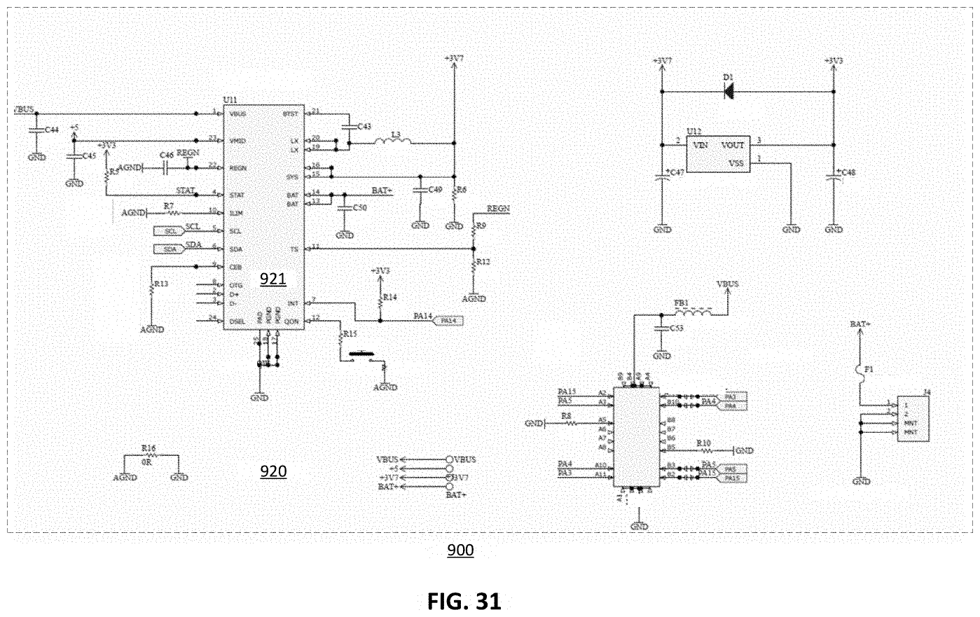

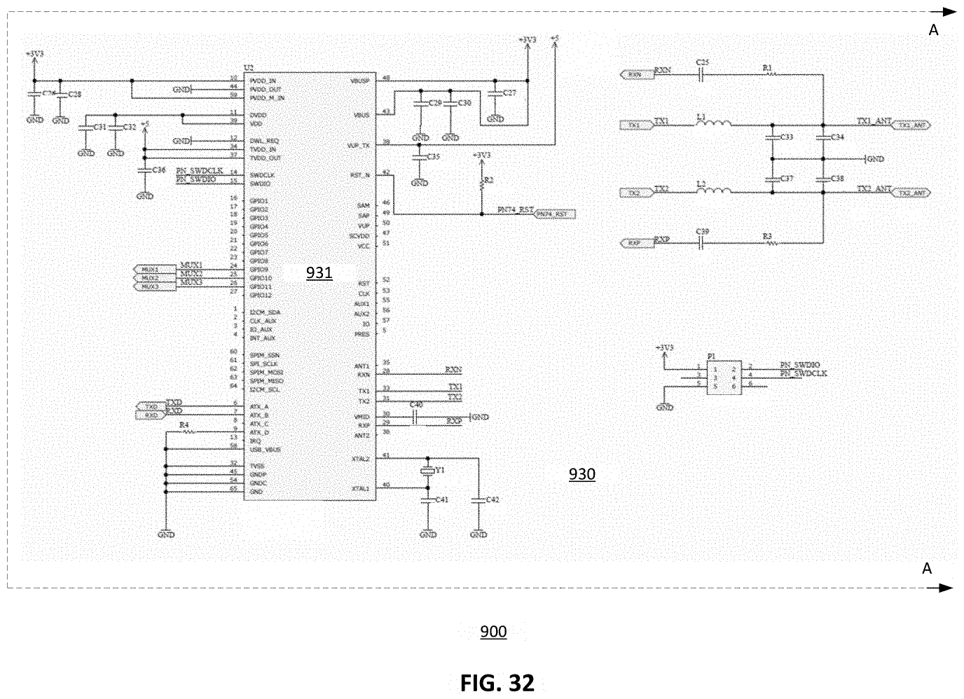

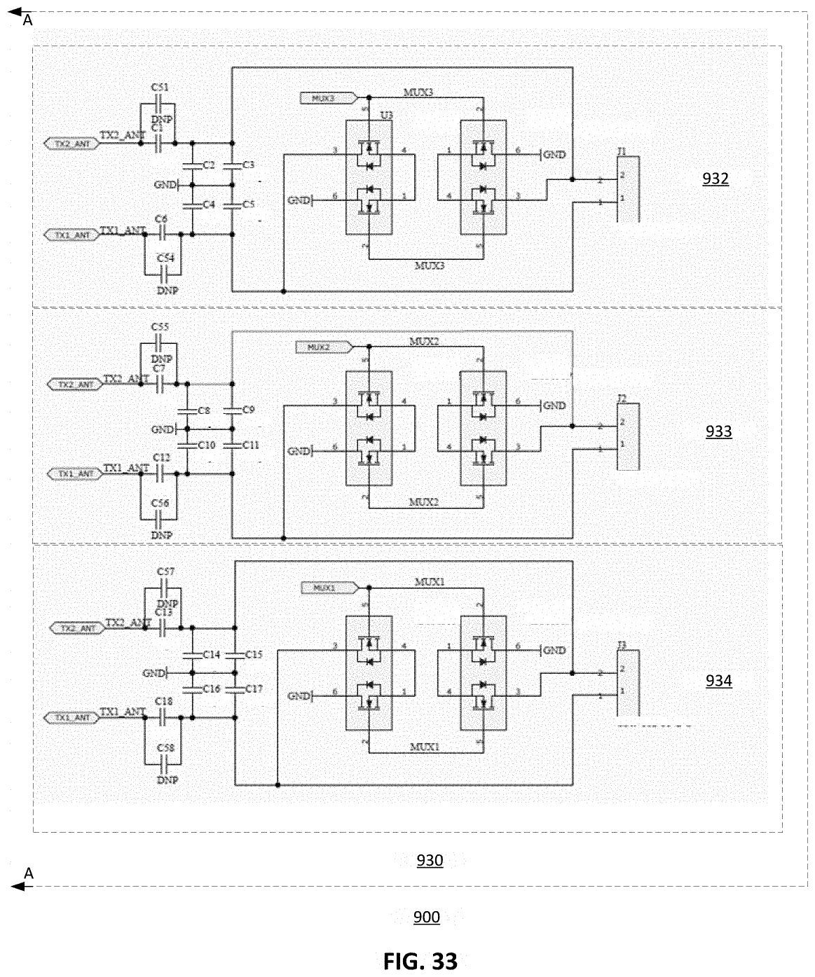

Next, FIGS. 30-33 depict circuitry 900 that may be included in a smart toy, such as a smart figurine (e.g., figurine 100 of FIG. 2), of the interactive toy system presented herein. The circuitry 900 includes operational circuitry 910 (FIG. 30), power management circuitry 920 (FIG. 31), and tag communication circuitry 930 (FIGS. 32 and 33). However, to be clear, the circuitry 900 is only referred to as operational circuitry 910, power management circuitry 920, and tag communication circuitry 930 for simplicity and ease of understanding and does not in any way require that the circuitry 900 be provided in unique modules or distinct groupings (although it may, if desired). Instead, operational circuitry 910, power management circuitry 920, and tag communication circuitry 930 are interconnected and may be formed together or separately, as desired.

That said, the operational circuitry 910 includes an integrated circuit (IC) 911, memory 912, such as flash memory, an accelerometer 913, a light array 914, a power switch 915, and a speaker 916. Generally, the IC 911 may read instructions from the memory 912 to operate various components of the operational circuitry 910, such as to indicate a status of the interactive toy (e.g., battery/charging status) via the light array 914 and/or cause the speaker 916 to emit audio associated with a tag read by tag communication circuitry 930. The IC 911 may also process inputs from components of the interactive toy, such as the accelerometer 913. Meanwhile, the power switch 915 may turn the circuitry 900 on and off and/or switch the circuitry between volume modes (e.g., high and low).

Next, FIG. 31 illustrates power management circuitry 920, which includes power management IC 921. The power management circuitry 920 may selectively power certain components of circuitry 900, for example, to cycle through tag reading antennas and/or to provide power to effects modules that will produce an effect in response to a read tag. Generally, the power management circuitry 920 may ensure that the interactive toy operates efficiently and maintains battery power over a long play periods.

Finally, FIGS. 32 and 33 illustrate tag communication circuitry 930 that includes an NFC controller 931, a front torso antenna 932, a hand antenna 933, and back torso antenna 934. Again, this is just an example and other embodiments need not utilize NFC and/or need not include the exact arrangement of antennas (both in terms of antenna construction and the number/placement of antennas). As is described in further detail the front torso antenna 932, the hand antenna 933, and the back torso antenna 934 are coupled to the NFC controller 931 in a manner that allows the NFC controller 931 to periodically cycle through the antennas 932, 933, and 934 (e.g., selectively activate the antennas).

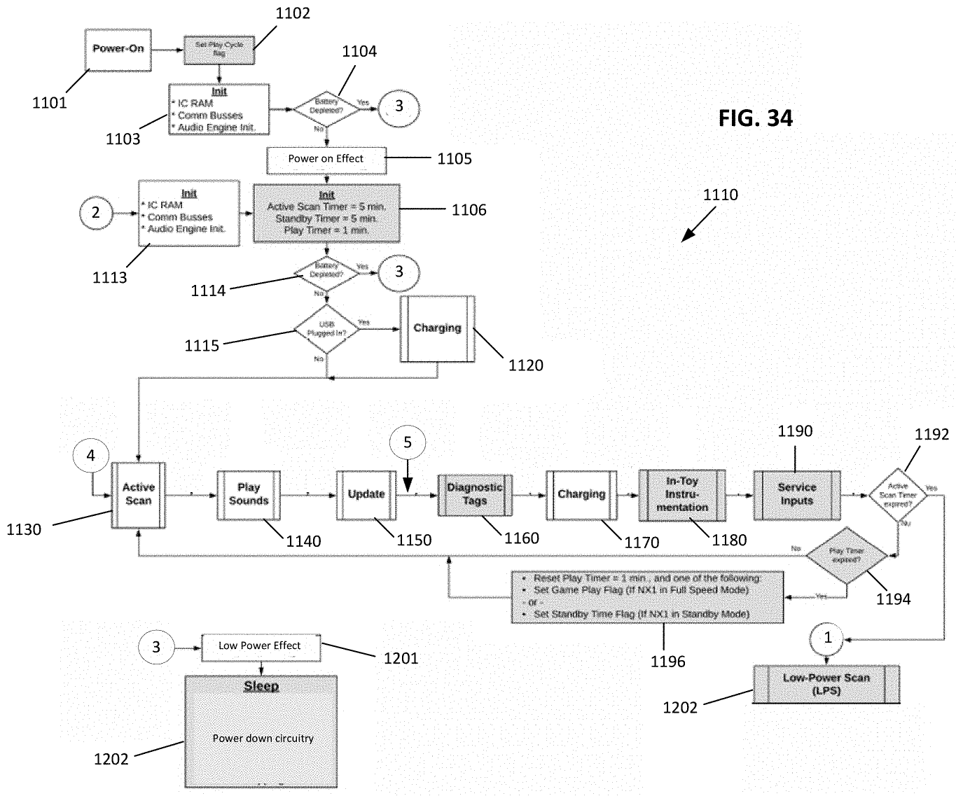

Now turning to FIGS. 34-36, the Figures provide flow charts illustrating operational sequences that can be implemented by an interactive toy, such as an interactive toy figurine, of the interactive toy system presented herein, according to an example embodiment. For example, the operational sequences depicted in FIGS. 34-36 may be executed by the circuitry of FIGS. 30-33. To be clear, while these operational sequences are generally described as being executed by the interactive toy or circuitry thereof, this descriptive language is just used for simplicity and it should be understood that appropriate components or combinations of components, such as processors, ICs, etc. included in the interactive toy (and/or it circuitry), may execute the operations described below, as will be appreciate by those skilled in the art.

First, FIG. 34 depicts a “main loop” 1110 (i.e., a primary logic sequence) that may be executed by circuitry of the interactive toy. The operational sequence begins at 1101, when the interactive toy is powered on. Once the circuitry is powered on, a play cycle flag is set at 1102. Then, various circuitry components (e.g., IC RAM, communication busses, and the audio engine) are initialized at 1103 and the battery status is checked at 1104. If the battery is depleted, the interactive toy will enter a lower power mode by generating a lower power effect (e.g., a specific sound) at 1201 and powering down circuitry components at 1202. If, instead, the power is sufficient, the interactive toy will generate a power-on effect (e.g., a specific sound) at 1105 and initialize timers at 1106. For example, at 1106, an active scan timer, a standby timer, and a player timer can be initialized for five minutes, five minutes, and one minute, respectively.

After initializing the timers, the circuitry checks the batteries again at 1114 and determines if the interactive toy is connected to power at 1115. Again, if the batteries are depleted, the interactive toy can enter a lower power mode at 1201 and 1202. Alternatively, if the interactive toy is plugged into power, the interactive toy can initialize charging operations at 1120. If the interactive toy has battery power and/or is connected to external power, the interactive toy begins to execute various operations after initializing its circuitry components and the various timers. Specifically, at 1130, the circuitry begins an active scan where the interactive toy cycles through its antenna to detect tags in proximity to the interactive toy (as described in further detail herein). Depending on the detected tags, the interactive toy may then begin to play sounds at 1140, update at 1150, execute diagnostics at 1160, charge at 1170, check instrumentation, and/or service inputs at 1190. Each of these operations are discussed further below. After executing one or more of these operations, the active scan timer is checked at 1192 and the play timer is checked at 1194.

If the active scan and play timers have not expired (as determined at 1192 and 1194, respectively), the interactive toy should continue to execute operations 1130, 1140, 1150, 1160, 1170, 1180, and/or 1190. On the other hand, the play timer expires before the active timer, the interactive toy may reset the play timer and set a new a new game play or standby flag at 1196. Still further, if the active scan timer expires, the interactive toy may enter a low power scan mode at 1202.

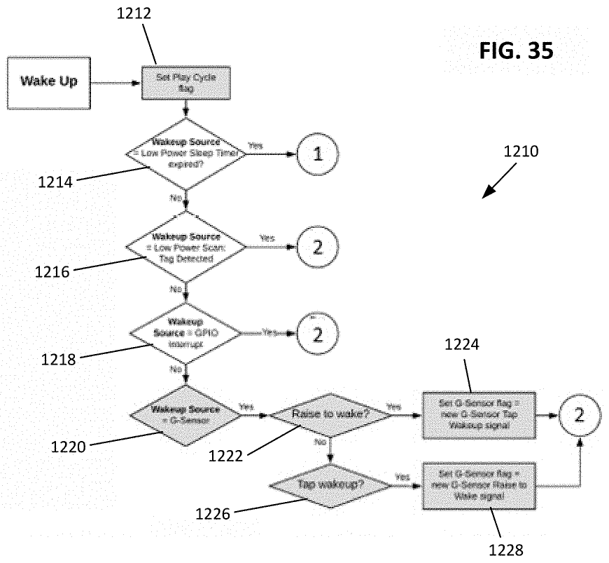

Now turning to FIG. 35, when the interactive toy is in a sleep mode, waking the interactive toy may cause the interactive toy to re-enter the main loop sequence 1110, as is illustrated by wake-up operations 1210. More specifically, initially, on waking up, the circuitry may set a flag at 1212. Then, at 1214, 1216, 1218, and/or 1220, the interactive toy attempts to determine why the interactive toy woke-up and responds accordingly. For example, if the wake-up source is determined, at 1214, to be expiration of the sleep timer, the toy may enter low power scanning mode at 1202 (see FIG. 34). By comparison, if the wake-up source is determined to be detection of a tag or a general-purpose input/output (GPIO) interruption at 1216 or 1218, respectively, the interactive toy may initialize computing components of the circuitry at 1113 of FIG. 34 (which is identical to 1103).

Still further, if the wake-up is, at 1220, determined to be based on movement detection from a “g-sensor” (e.g., from accelerometer 913 of FIG. 30), the interactive toy may analyze the movement data in view of wake-up rules to determine if the interactive toy should initialize computing components of the circuitry at 1113 of FIG. 34. Specifically, the interactive toy will determine if raise-to-wake rules are being implemented at 1222 and/or determine if tap-to-wake rules are being implemented at 1226. If either rule is being implemented, the interactive toy may set new flags at 1224 and/or 1228, respectively, and initialize computing components of the circuitry at 1113 of FIG. 34.

Now turning back to FIG. 34, in different embodiments, active scanning operations 1130, sound operations 1140, update operations 1150, diagnostic operations 1160, charging operations 1120/1170, instrumentation operations 1180, service operations 1190, and low power scanning operations 1202 of main loop 1110 may involve different logical and/or operational sequences. For brevity, only the update operations 1150 are depicted in detail in the Figures (and are described in detail below); but, for completeness, example embodiments of each of the other operations are briefly described in turn below.

First, sound operations 1140 may be controlled in the manner described above (e.g., in connection with at least FIGS. 5 and 6) and, thus, the controller may operate a speaker to produce one or more sounds based on identities of tags read by the interactive toy's circuitry (e.g., read by antennas 932, 933, and 934).

Second, active scanning operations may involve selectively providing power to the antennas in the interactive toy for a limited amount of time (e.g., 10-20 ms per antenna) to, in essence, cycle through the antennas to quickly detect any tags in proximity to the interactive toy. For example, the active scanning operations may first activate a first antenna (e.g., hand antenna 933 of FIG. 33) for 20 ms. If one or more tags are present near this antenna, the circuitry may process the tag identity or identities and produce one or more associated effects, as discussed in detail above. However, if no tags are read, the first antenna may be powered down and a second antenna (e.g., a front torso antenna 932) may be activated for 20 ms. Again, if one or more tags are present near this antenna, the circuitry may process the tag identity or identities and produce one or more associated effects, as discussed in detail above. Finally, if no tags are read at the second antenna, the second antenna may be powered down and a third antenna (e.g., a back torso antenna 934) may be activated for 20 ms. Yet again, if one or more tags are present near this antenna, the circuitry may process the tag identity or identities and produce one or more associated effects, as discussed in detail above.

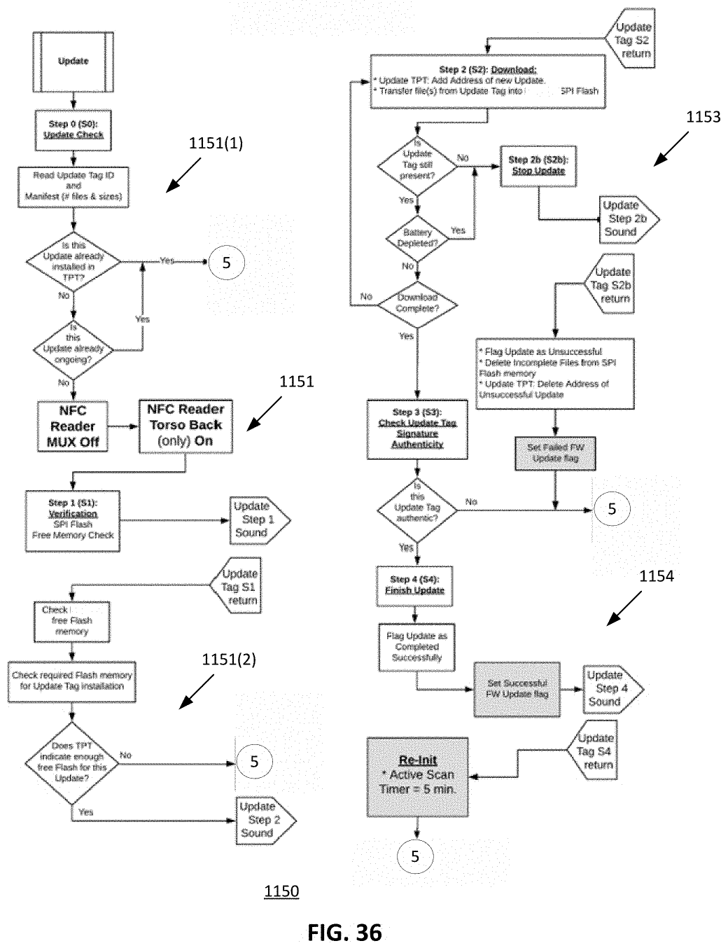

After cycling through the antennas, the active scanning may re-cycle in reverse (e.g., third antenna, then second antenna, then first antenna following a scan of the first to third or vice versa) or repeat the loop (e.g., first to third, followed by first to third). Moreover, in some instances, an activated antenna may detect more than one tag. In these instances, the antenna can read multiple tags simultaneously. However, some embodiments may limit the number of tags read simultaneously, for example to a limit of three tags. In such embodiments, the oldest tags can be discarded when the number of detected tags exceed the limit. Still further, if any of the antennas detects an update tag, the circuitry may execute update operations, which are described in further detail below in connection with FIG. 36.

Third, diagnostic operations 1160 may allow the interactive toy to enter a test mode and/or scan the temperatures of various components included therein. The tests may check connections between circuitry components, erase memory, upload test scripts to memory, ensure that antennas are functioning, ensure that content is being properly downloaded to the interactive toy (e.g., from an update tag), and/or any perform other diagnostic operation. The tests may also ensure that effects modules (e.g., lights and speakers) are functioning properly.

Fourth, charging operations 1120/1170 may involve monitoring operations of the power management IC (“PMIC”) of the interactive toy's circuitry (e.g., power management IC 921 of FIG. 31). For example, if the PMIC stops charging, the charging operations may provide an indication of whether the battery is fully or partially charged, such as with a solid red light indicating low battery, orange flashing lights indicating that charging is ongoing, and green lights indicating the battery is fully charged.

Fifth, instrumentation operations 1180 may track operations of the interactive toy based on tags read at antennas, accelerometer input, memory updates, etc. For example, the instrumentation operations may increment metrics in response to tags being read, firmware updates, audio channel overlaps, battery charges, etc. These operations may maintain any number of metrics tied, independently or separately, to any number of operations.

Sixth, service operations 1190 may coordinate user actions and/or circuitry operations. For example, the service operations may set G-sensor flags based on the scan mode of the interactive toy (active scanning or lower power scanning), set volume settings based on user switch selections (e.g., of low volume of high volume via a switch, such as switch 915 of FIG. 30) and/or coordinate light indications (e.g., at a light array, such as light array 914 of FIG. 30) based on switch, battery, or charging statuses/settings.

Seventh, and finally, low power scanning operations 1202 may involve cycling through each of the antenna included in a doll (e.g., selectively providing power antennas 932, 933, and 934) for a limited amount of time (e.g., 10-20 ms per antenna) and then entering a sleep mode for a longer period of time (e.g., 500 ms). This may preserve the battery of the interactive toy without fully disabling the interactive toy.

Now turning to FIG. 36, as mentioned, this Figure depicts the update operations 1150 of FIG. 34 in detail. The update operations can be executed when active or low power scanning detects an update tag and, notably, is a separate operation from the play pattern tag reading operations. This is because more time is required to transfer a larger amount of data associated with an update (as compared to a quick tag read to obtain a tag identity). Overall, the update operations include three steps: a first step 1151 that checks to see if the update is needed and that memory is available for the update, a second step 1153 that downloads data for the update, and a third step 1154 that verifies the authenticity of the update.

The first step 1151 is a two-part step. The first part 1151(1) of step 1151 involves reading the update tag ID and the manifest, which indicates the number and size(s) of files involved in the update. Then, using the update tag ID, the update operations 1150 determine if the update has already been installed in the interactive toy. If so, update operations terminate and the interactive toy continues with main loop operations 1110 (see FIG. 34). If not, the logic ensures that the update is not currently ongoing. Provided that the update is not currently ongoing, the interactive toy turns off all tag readers (e.g., NFC readers) except for a reader dedicated to updates (e.g., the back torso tag reader, such as antenna 934 of FIG. 33, if this reader can read update tags in clothing, as described above in connection with FIGS. 11-12), initiates a memory check (the second part 1151(2) of step 1151), and emits a sound or effect that indicates an update is starting.

The second part 1151(2) of step 1151 compares the free memory of the interactive toy with the size of the data in the update, as indicated in the manifest of the update tag. If the interactive toy has enough free memory to receive the files, the update logic initiates the second step 1153. If not, update operations terminate and the interactive toy continues with main loop operations 1110 (see FIG. 34).

During second step 1153, the interactive toy downloads data from the update tag. During the download process, the interactive toy continuously checks the battery life and the presence of the update tag. If the battery is depleted or the update tag is no longer present at the dedicated tag reader (e.g., back torso antenna 934 of FIG. 33) update operations may stop. Then, either immediately or once power is restored, the update may be marked unsuccessful, all data associated with the halted update may be deleted, and the interactive toy may continue with main loop operations 1110 (see FIG. 34). However, if the data download completes, the update logic 1150 may then move to the third step 1154.

During the third step 1154, the update logic 1150 authenticates the update tag. Any security measures now known or developed hereafter can be used for authentication, such as keys and cryptographic hashing. For example, the update tag may use a public key to deliver the update and the interactive toy may use a private key to decrypt authenticating information. If the update tag is successfully authenticated, the update is implemented and the interactive toy hardware is re-initialized and main loop operations 1110 continue (see FIG. 34).

While the interactive toy system presented and portions thereof have been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the interactive toy system described herein, or portions thereof, may be fabricated from any suitable material or combination of materials, such as plastic, foamed plastic, wood, cardboard, pressed paper, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof

Still further, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

What is claimed is:

1. A toy system, comprising:
a first accessory including a first tag; and
a toy including:
a head, a torso, and one or more appendages;
a first tag reader and a second tag reader disposed in the torso, the one or more appendages, or a combination thereof;
an effects module configured to produce a sound effect, a light effect, or a combination thereof; and
control circuitry configured to:
cause the effects module to produce a first effect when the first tag reader reads the first tag; and
cause the effects module to produce a second effect when the second tag reader reads the first tag.

2. The toy system of claim 1, wherein the control circuitry is further configured to:
cause the effects module to produce a third effect when the first tag reader or the second tag reader reads a second tag included in a second accessory within a predetermined amount of time of reading the first tag.

3. The toy system of claim 2, wherein the first effect is a sound effect associated with the first accessory, the second effect is a sound effect associated with the second accessory, and the third effect is a multi-layered sound effect including layers associated with the first accessory and the second accessory.

4. The toy system of claim 2, wherein the control circuitry is further configured to:
cause the effects module to produce a fourth effect when the first tag reader or the second tag reader reads the first tag within a predetermined amount of time of reading the second tag.

5. The toy system of claim 4, wherein the third effect and the fourth effect are different multi-layered sound effects, but each include layers associated with the first accessory and the second accessory.

6. The toy system of claim 4, wherein the control circuitry is further configured to:
cause the effects module to produce a fifth effect when the second tag reader reads a third tag of a third accessory within a predetermined amount of time of reading the first tag.

7. The toy system of claim 1, further comprising:
a playset including a second tag,
wherein the control circuity of the toy is further configured to:
cause the effects module to produce a third effect when the first tag reader reads the second tag; and
cause the effects module to produce a fourth effect when the second tag reader reads the second tag.

8. The toy system of claim 1, wherein the first accessory is part of a first set of accessories, the first tag is part of a first set of tags, and the toy system further comprises:
a second accessory including an update tag configured to update the control circuitry to recognize a second set of accessories including tags from a second set of tags, the second set of tags including tags that are unique from the first set of tags included in the first set of accessories.

9. The toy system of claim 8, wherein the second accessory is a piece of clothing and the update tag is included in a pocket disposed on a back portion of the piece of clothing.

10. The toy system of claim 1, wherein the first accessory is configured to draw power from the toy when the first tag reader or the second tag reader reads the first tag.

11. A toy figurine comprising:
a head, a torso, and at one or more appendages;
a first tag reader disposed in the torso;
a second tag reader disposed in a first appendage of the one or more appendages;
an effects module configured to produce a sound effect, a light effect, or a combination thereof; and
control circuitry configured to:
cause the effects module to produce a first effect when the first tag reader reads a first tag; and
cause the effects module to produce a second effect when the second tag reader reads the first tag.

12. The toy figurine of claim 11, wherein the control circuitry is further configured to:
cause the effects module to produce a third effect when the first tag reader or the second tag reader reads a second tag within a predetermined amount of time of reading the first tag.

13. The toy figurine of claim 12, wherein the control circuitry is further configured to:
cause the effects module to produce a fourth effect when the first tag reader or the second tag reader reads the first tag within a predetermined amount of time of reading the second tag.

14. The toy figurine of claim 11, wherein the effects module comprises a speaker configured to emit audio.

15. The toy figurine of claim 11, wherein the first appendage is an arm that includes an elbow and the elbow defines a circular wire path for a wire connecting the second tag reader to the control circuitry while allowing articulation of the arm about the elbow.

16. The toy figurine of claim 15, wherein the elbow comprises:
a split boss including a slot and a rounded outer edge, the circular wire path extends from an upper arm portion of the arm to a lower portion of the arm by extending through the slot and wrapping around a portion of the rounded outer edge.

17. The toy figurine of claim 11, wherein the first tag is part of a first set of tags, and the control circuitry is further configured to:
receive an update from an update tag that updates the control circuitry to recognize a second set of tags, the second set of tags including tags that are unique from the first set of tags.

18. A method comprising:
receiving, at a processor included in a smart toy of an interactive toy play system, data received from a first tag read by a tag reader of the smart toy;
causing an effects module included in the smart toy to produce a first effect when a first tag reader read the first tag; and
cause the effects module to produce a second effect when a second tag reader read the first tag.

19. The method of claim 18, further comprising:
causing the effects module to produce a third effect when the first tag reader or the second tag reader reads a second tag within a predetermined amount of time of reading the first tag.

20. The method of claim 18, wherein the first tag is part of a first set of tags, and the method further comprises:
receiving an update from an update tag that updates the processor to recognize a second set of tags, the second set of tags including tags that are unique from the first set of tags.
